(19) United States
(12) Patent Application Publication
(10) Pub. No.: US 2025/0225903 A1
(43) Pub. Date: Jul. 10, 2025

(54) ELECTRONIC DEVICE AND METHOD FOR DISPLAYING INITIAL IMAGE ON DISPLAY PANEL

(71) Applicant: SAMSUNG ELECTRONICS CO., LTD., Suwon-si (KR)

(72) Inventors: Jaesung LEE, Suwon-si (KR); Kyounghwan KWON, Suwon-si (KR); Jongkon BAE, Suwon-si (KR); Kwangtai KIM, Suwon-si (KR); Donghyun YEOM, Suwon-si (KR)

(21) Appl. No.: 19/093,861

(22) Filed: Mar. 28, 2025

(30) Foreign Application Priority Data
Sep. 30, 2022 (KR) 10-2022-0125365
Jan. 4, 2023 (KR) 10-2023-0001471
Jan. 11, 2023 (KR) 10-2023-0004347
Jan. 11, 2023 (KR) 10-2023-0004350
Jan. 31, 2023 (KR) 10-2023-0013290
Feb. 8, 2023 (KR) 10-2023-0016868
Feb. 27, 2023 (KR) 10-2023-0026369
Feb. 28, 2023 (KR) 10-2023-0026723
Mar. 17, 2023 (KR) 10-2023-0035417
Mar. 30, 2023 (KR) 10-2023-0041991
Sep. 25, 2023 (WO) PCT/KR2023/014711
Sep. 26, 2023 (WO) PCT/KR2023/014939
Sep. 26, 2023 (WO) PCT/KR2023/014940

(51) Int. Cl. G09G 3/20

(52) U.S. Cl. CPC G09G 3/20; G09G 2330/023; G09G 2330/026; G09G 2340/0435

(57) ABSTRACT

An electronic device may comprise: at least one processor; comprising processing circuitry and a display including a display driving circuit and a display panel. At least one processor, individually and/or collectively, may be configured to: activate periodic transmissions of a pulse signal from at least one processor to the display driving circuit in order to synchronize at least one timing for the display driving circuit with at least one timing for at least one processor before providing a first command for a sleep-out state of the display to the display driving circuit; and provide a second command for a display-on state of the display to the display driving circuit based on using the periodic transmissions to inform the display driving circuit of timing of an emission synchronization signal for at least one processor available for image transmission from at least one processor to the display driving circuit.

### CROSS-REFERENCE TO RELATED APPLICATIONS

This application is a continuation of International Application No. PCT/KR2023/015149 designating the United States, filed on Sep. 27, 2023, in the Korean Intellectual Property Receiving Office and claiming priority to International Application Nos. PCT/KR2023/014711, filed on Sep. 25, 2023, PCT/KR2023/014939, filed on Sep. 26, 2023 and PCT/KR2023/014940, filed on Sep. 26, 2023, in the Korean Intellectual Property Receiving Office, and to Korean Patent Application Nos. 10-2022-0125365, filed on Sep. 30, 2022, 10-2023-0001471, filed on Jan. 4, 2023, 10-2023-0004347, filed on Jan. 11, 2023, 10-2023-0004350, filed on Jan. 11, 2023, 10-2023-0013290, filed on Jan. 31, 2023, 10-2023-0016868, filed on Feb. 8, 2023, 10-2023-0026369, filed on Feb. 27, 2023, 10-2023-0026723, filed on Feb. 28, 2023, 10-2023-0035417, filed on Mar. 17, 2023, and 10-2023-0041991, filed on Mar. 30, 2023, in the Korean Intellectual Property Office, the disclosures of each of which are incorporated by reference herein in their entireties.

### BACKGROUND

### Field

The disclosure relates to an electronic device and a method for displaying an initial image on a display panel.

### Description of Related Art

An electronic device may include a display panel. For example, the electronic device may include display driver circuitry operably coupled with the display panel. For example, the display driver circuitry may display an image obtained from a processor of the electronic device on the display panel.

The above-described information may be provided as a related art for the purpose of helping to understand the present disclosure. No assertion or determination is made as to whether any of the above-described information may be applied as a prior art related to the present disclosure.

### SUMMARY

According to an example embodiment, an electronic device is provided. The electronic device may comprise: at least one processor, comprising processing circuitry; a display including display driver circuitry and a display panel, wherein at least one processor, individually and/or collectively, may be configured to: before providing, to the display driver circuitry, a first command for a sleep out state of the display, enable periodic transmissions of a pulse signal from at least one processor to the display driver circuitry to synchronize at least one timing for the display driver circuitry with at least one timing for at least one processor; and based on informing the display driver circuitry using the periodic transmissions, a timing of an emission synchronization signal for at least one processor usable for an image transmission from at least one processor to the display driver circuitry, provide, to the display driver circuitry, a second command for a display on state of the display.

According to an example embodiment, a method is provided. The method may be executed in an electronic device comprising a processor, and a display including display driver circuitry and a display panel. The method may comprise: before providing, to the display driver circuitry, a first command for a sleep out state of the display, enabling periodic transmissions of a pulse signal from at least one processor to the display driver circuitry to synchronize at least one timing for the display driver circuitry with at least one timing for the processor; and based on informing the display driver circuitry using the periodic transmissions, a timing of an emission synchronization signal for at least one processor usable for an image transmission from the processor to the display driver circuitry, providing, to the display driver circuitry, a second command for a display on state of the display.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a block diagram illustrating an example configuration of an example electronic device according to various embodiments;

FIG. 2 is a diagram illustrating an example of a first mode for initial driving of a display according to various embodiments;

FIG. 3 is a diagram illustrating an example of a first mode for initial driving of a display according to various embodiments;

FIG. 4 is a diagram illustrating an example of a second mode for initial driving of a display according to various embodiments;

FIG. 5 is a diagram illustrating an example of a second mode for initial driving of a display according to various embodiments;

FIG. 6 is a diagram illustrating an example of a third mode for initial driving of a display according to various embodiments;

FIG. 7 is a diagram illustrating an example of a third mode for initial driving of a display according to various embodiments;

FIG. 8 is a diagram illustrating an example method for terminating driving of a display according to various embodiments;

FIG. 9 is a block diagram illustrating an example electronic device in a network environment according to various embodiments; and

FIG. 10 is a block diagram illustrating an example configuration of a display module according to various embodiments.

### DETAILED DESCRIPTION

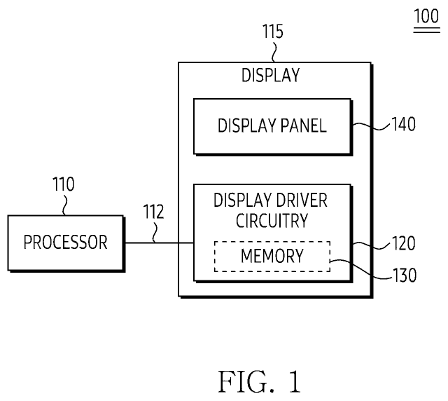

FIG. 1 is a block diagram illustrating an example configuration of an electronic device according to various embodiments.

Referring to FIG. 1, an electronic device 100 may include a processor (e.g., including processing circuitry) 110 and a display 115.

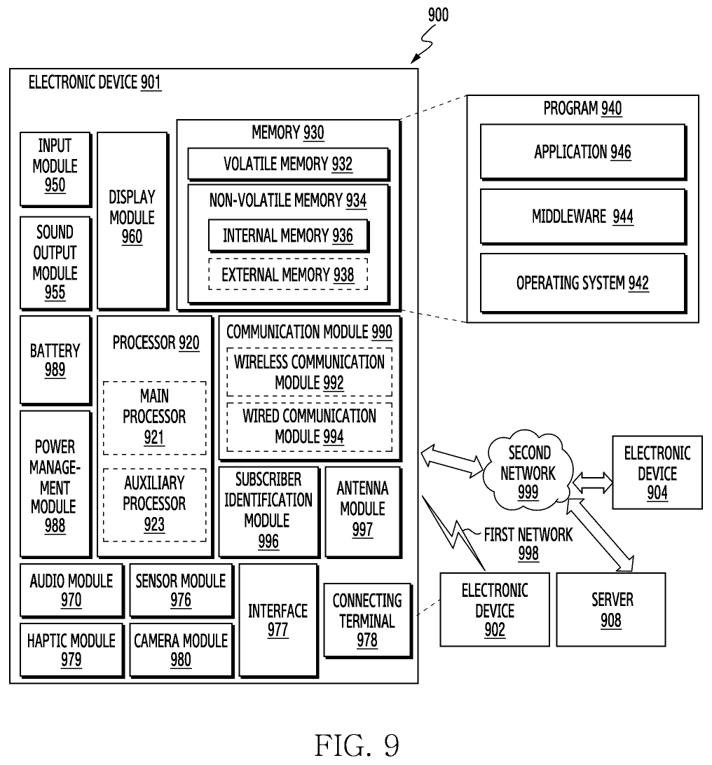

The processor 110 may include at least a portion of the processor 920 of FIG. 9. The processor 110 may be operably coupled with display driver circuitry 120 (or the display 115). The processor 110 being operably coupled with the display driver circuitry 120 may indicate that the processor 110 is directly or indirectly connected with the display driver circuitry 120. For example, the processor 110 being operably coupled with the display driver circuitry 120 may indicate that the processor 110 is connected to the display driver circuitry 120 through an interface 112 (e.g., mobile industry processor interface (MIPI)) for an image transmission from the processor 110 to the display driver circuitry 120. For example, the interface 112 may be further used to provide, from the processor 110 to the display driver circuitry 120, commands related to displaying on the display panel 140. For example, the commands may include at least one command for initial driving of the display 115. For example, the processor 110 being operably coupled with the display driver circuitry 120 may indicate that it is connected to the display driver circuitry 120 through at least one interface for at least one signal to synchronize at least a portion of operations of the processor 110 related to displaying and at least a portion of operations of the display driver circuitry 120 related to displaying. For example, the at least one signal may include a pulse signal to be illustrated and described in greater detail below. For example, the at least one interface may be provided from the display driver circuitry 120 to the processor 110 and used for a signal indicating whether to enable or disable an image transmission from the processor 110 to the display driver circuitry 120. As a non-limiting example, the pulse signal may be referred to as an external synchronization signal (Esync). As a non-limiting example, the signal may be referred to as a refresh window (RW) signal (or RW). For example, the signal may be implemented in a level mode that defines an operation according to a state of the signal, or in an edge mode that defines an operation according to a change in a state of the signal. The processor 110 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

For example, the at least one interface may include various circuitry and be provided from the display driver circuitry 120 to the processor 110 and used for a signal indicating a timing of the image transmission. For example, the at least one interface may be included within the interface 112 or may be separated from the interface 112.

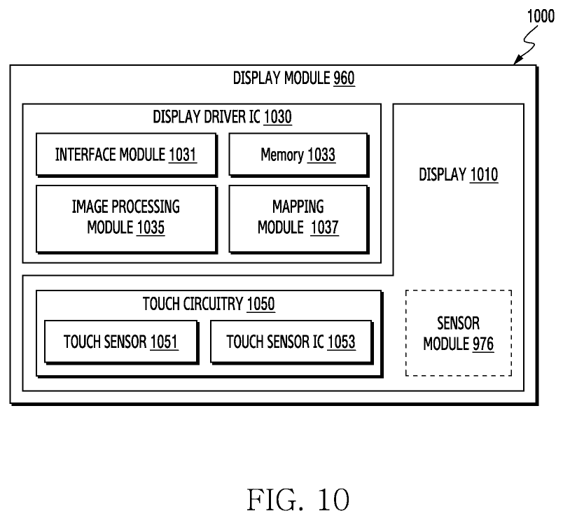

The display 115 may include at least a portion of the display module 960 of FIGS. 9 and 10. The display 115 may include display driver circuitry 120 and a display panel 140.

The display driver circuitry 120 may include at least a portion of the DDI 1030 of FIG. 10. The display driver circuitry 120 may include memory 130. The memory 130 may include at least a portion of the memory 1033 of FIG. 10. The memory 130 may be referred to as a graphic random access memory (GRAM) or a frame buffer memory. According to embodiments, the memory 130 may not be included in the display driver circuitry 120 or may be disabled in the display driver circuitry 120.

The display panel 140 may include at least a portion of the display 1010 of FIG. 10.

For example, the processor 110 may execute an image transmission from the processor 110 to the display driver circuitry 120. For example, the processor 110 may execute the image transmission based on an emission interval. For example, the emission interval may be indicated based on an emission synchronization signal. For example, the processor 110 may identify the emission interval based on the emission synchronization signal for the processor 110. For example, the display driver circuitry 120 may identify the emission interval based on the emission synchronization signal for the display driver circuitry 120. For example, the emission synchronization signal for the processor 110 may be synchronized with the emission synchronization signal for the display driver circuitry 120. For example, the synchronization between the emission synchronization signal for the processor 110 and the emission synchronization signal for the display driver circuitry 120 may be obtained based on a pulse signal from the processor 110 to the display driver circuitry 120, which will be described in greater detail below.

For example, the emission synchronization signal for the processor 110 may be arranged with respect to a vertical synchronization signal for the processor 110 and may have a shorter period than a period of the vertical synchronization signal for the processor 110. For example, first start timings among start timings of the emission synchronization signal for the processor 110 may respectively overlap with start timings of the vertical synchronization signal for the processor 110, and second start timings among the start timings of the emission synchronization signal for the processor 110 may not overlap the timings of the vertical synchronization signal for the processor 110. For example, the second start timings may be within time intervals between the first start timings.

For example, since the emission synchronization signal for the processor 110 has a shorter period than a period of the vertical synchronization signal for the processor 110, opportunities of the image transmission executed based on the emission synchronization signal for the processor 110 may be greater than opportunities of the image transmission executed based on the vertical synchronization signal for the processor 110. For example, since the opportunities of the image transmission executed based on the emission synchronization signal for the processor 110 are greater than the opportunities of the image transmission executed based on the vertical synchronization signal for the processor 110, the processor 110 may adaptively change a refresh rate of displaying on the display panel 140 via the image transmission executed based on the emission synchronization signal for the processor 110. For example, the electronic device 100 may provide an enhanced service through the display 115, by executing the adaptive change of the refresh rate.

As a non-limiting example, the display driver circuitry 120 may display, on the display panel 140, an image received from the processor 110 and store, in the memory 130, the image received from the processor 110. For example, the display driver circuitry 120 may re-display, on the display panel 140, the image, by scanning the image stored in the memory 130. For example, in a mode of executing the image transmission at a timing identified by the processor 110 among the processor 110 and the display driver circuitry 120, the display driver circuitry 120 may store the image in the memory 130 and re-display the image on the display panel 140.

For example, re-displaying the image in the memory 130 may be at least partially different from displaying the image on the display panel 140 by scanning the image in the memory 130 in a mode of executing the image transmission at a timing identified by the display driver circuitry 120 among the processor 110 and the display driver circuitry 120. For example, a time interval for initially executing re-displaying of the image by scanning the image in the memory 130 within the mode for executing the image transmission at the timing identified by the processor 110 may be different from a time interval for storing the image in the memory 130 from the processor 110 within the mode for executing the image transmission at the timing identified by the processor 110. On the other hand, a time interval for initially executing displaying of the image by scanning the image in the memory 130 within the mode for executing the image transmission at the timing identified by the display driver circuitry 120 may be the same as a time interval for storing the image in the memory 130 from the processor 110 within the mode for executing the image transmission at the timing identified by the display driver circuitry 120.

As a non-limiting example, re-displaying the image by the display driver circuitry 120 through scanning the image in the memory 130 may not be recognized by the processor 110. For example, re-displaying the image by the display driver circuitry 120 through scanning the image in the memory 130 may be transparent to the processor 110. For example, since the processor 110 executes the image transmission based on the emission synchronization signal for the processor 110, the processor 110 may execute the image transmission while the image is re-displayed according to scanning the image in the memory 130. For example, since the image transmission executed while the image is re-displayed according to scanning the image in the memory 130 reduces a quality of a service provided through the display 115, the display driver circuitry 120 may provide, to the processor 110, a signal indicating whether the image transmission is enabled or disabled so that the processor 110 recognizes displaying the image according to scanning the image in the memory 130. For example, since the image transmission executed while the image is re-displayed according to scanning the image in memory 130 reduces the quality of the service, the display driver circuitry 120 may provide, to the processor 110, a signal indicating a timing of the image transmission so that the processor 110 recognizes displaying the image according to scanning the image in the memory 130. For example, since the image transmission executed while the image is re-displayed according to scanning the image in the memory 130 reduces the quality of the service, the processor 110 may execute the image transmission based on a start timing (and/or period) of the image transmission defined (or pre-defined) based on a refresh rate so that the image transmission is executed within a time interval during which the image is not displayed according to scanning the image in the memory 130. For example, the processor 110 may execute the image transmission based on the vertical synchronization signal for the processor 110 based on the refresh rate lower than a reference refresh rate, and may execute the image transmission based on the emission synchronization signal for the processor 110 based on the refresh rate higher than or equal to the reference refresh rate.

As a non-limiting example, each of the above-described methods available to reduce the execution of the image transmission while the image is re-displayed by scanning the image in the memory 130 may be executed while the display 115 is in a display on state (or display on mode, referred to as the display on state hereinafter) and a sleep out state (or sleep out mode, referred to as the sleep out state hereinafter). For example, the methods may not be applied at an initial driving of the display 115.

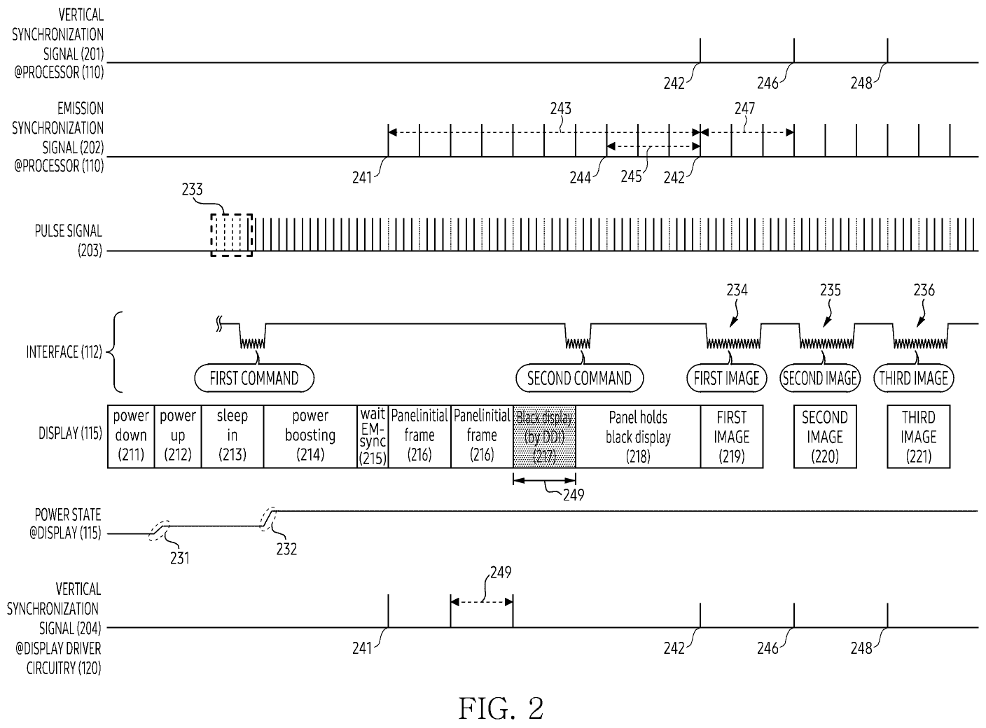

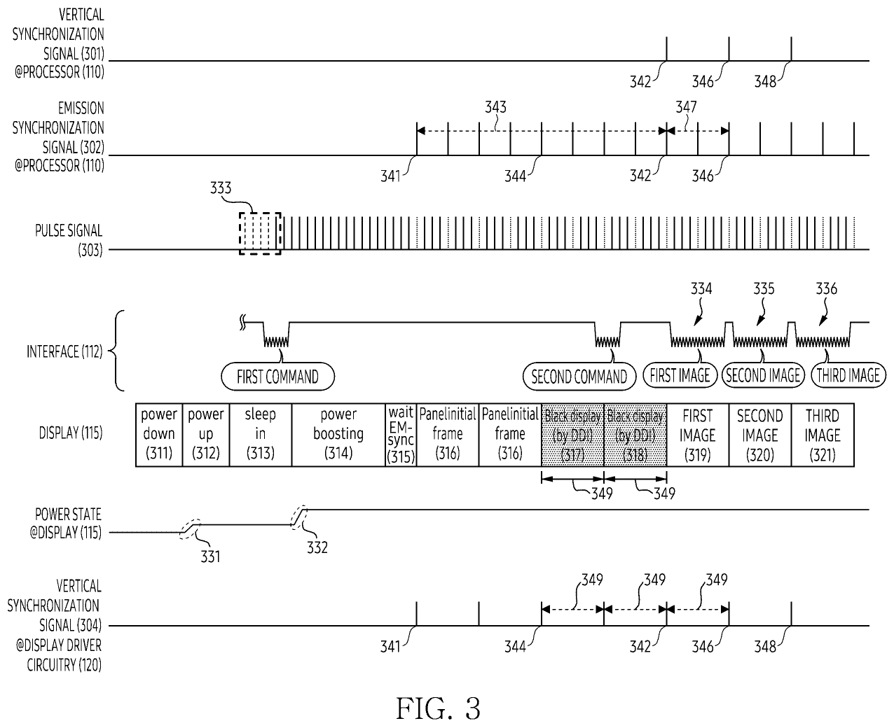

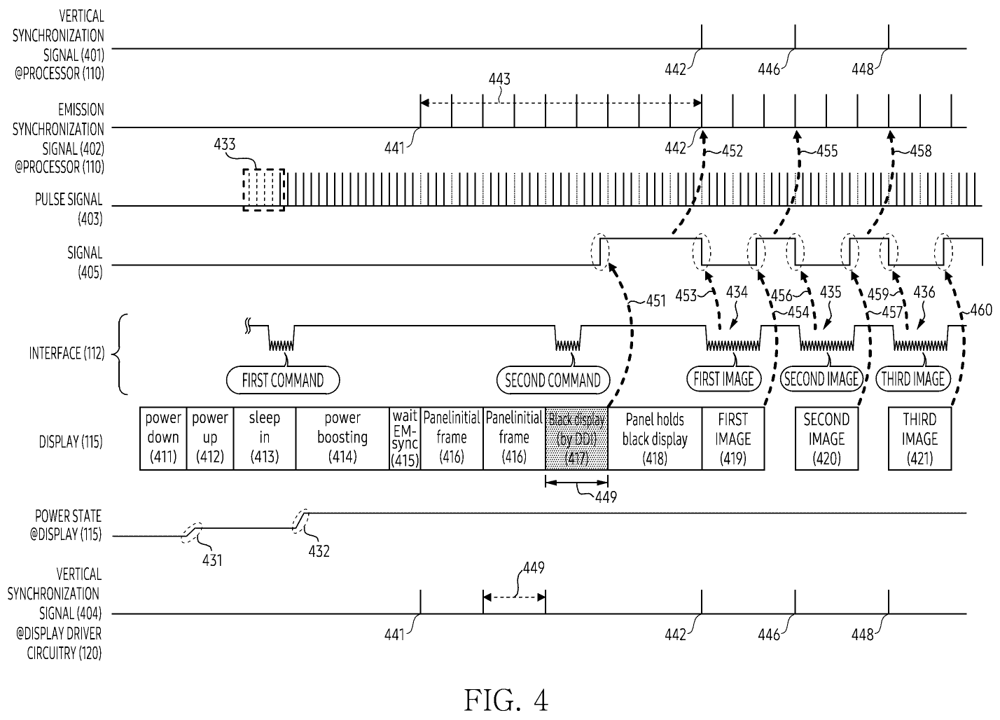

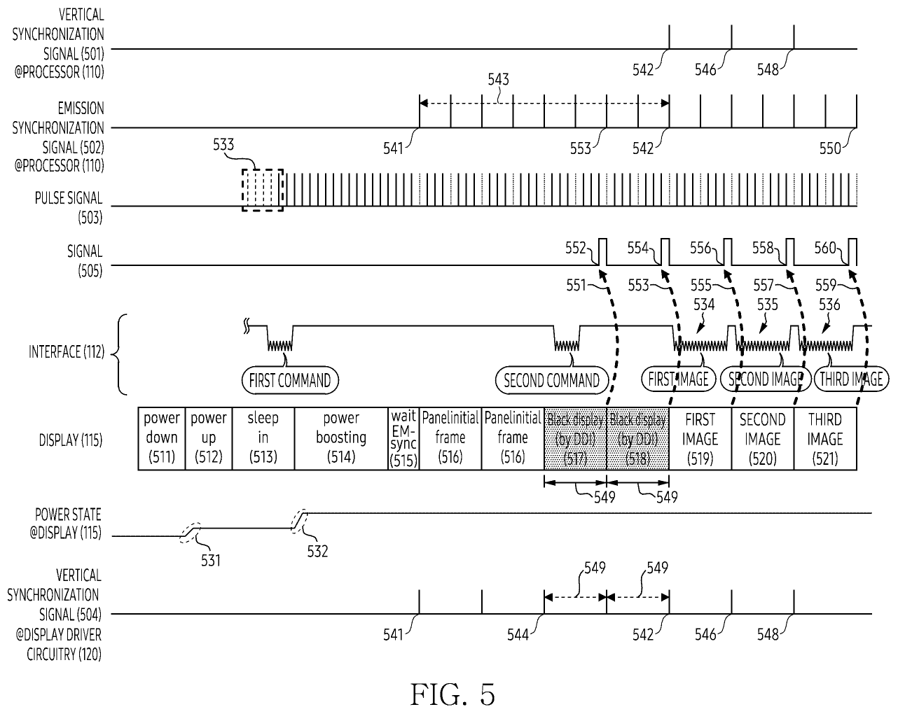

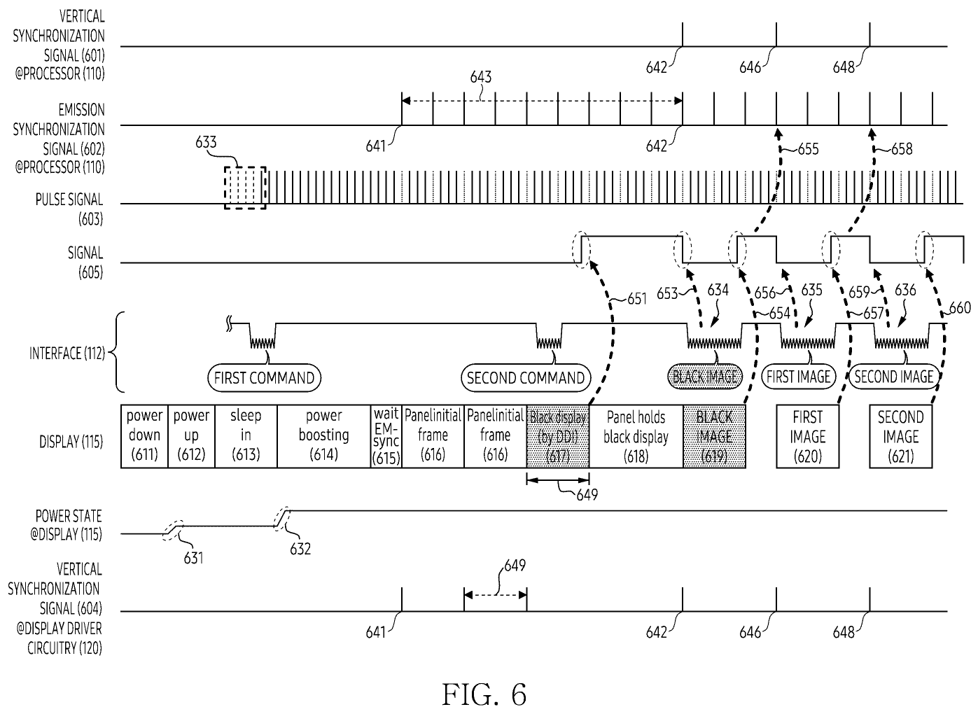

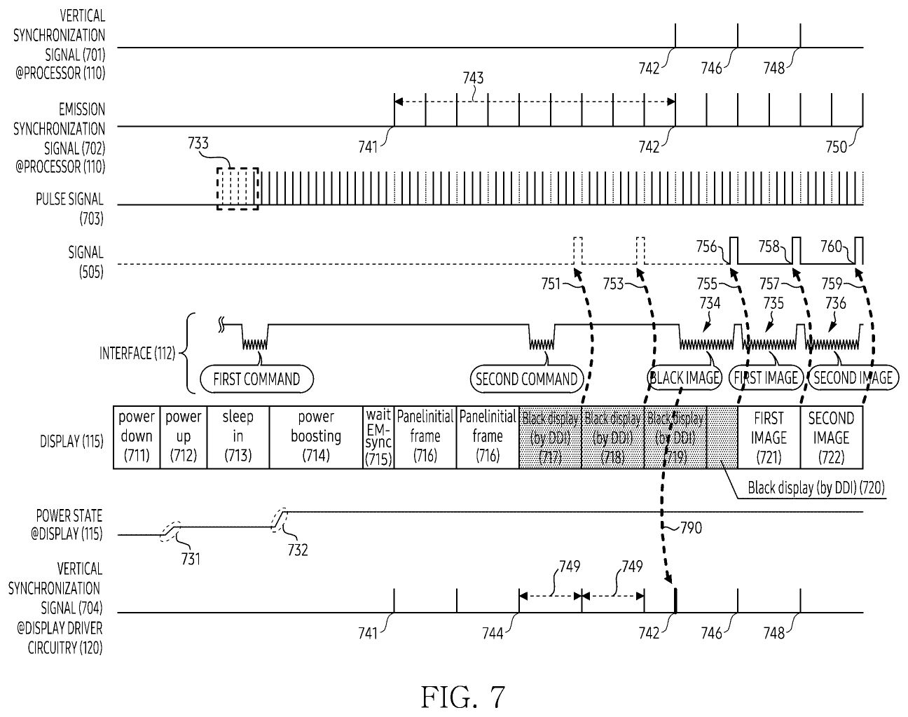

For example, the electronic device 100 may provide methods for the quality of the service provided through the display 115, the method for when an image (and/or a valid image) is initially transmitted from the processor 110 performing the image transmission based on the emission synchronization signal for the processor 110 after entering the sleep out state and the display on state. The methods may be executed by operations of the processor 110 and the display driver circuitry 120. The operations may be executed according to a first mode, a second mode, and/or a third mode. For example, the electronic device 101 may execute operations according to one of the first mode, the second mode, and the third mode when the display 115 is initially driven. As a non-limiting example, the electronic device 101 may identify one of the first mode, the second mode, and the third mode based on a state of the electronic device 101 and execute a transmission of an initial image (or initial valid image) from the processor 110 to the display driver circuitry 120 based on operations according to the identified mode. The first mode will be described in greater detail with reference to FIGS. 2 and 3, the second mode will be described in greater detail with reference to FIGS. 4 and 5, and the third mode will be described in greater detail with reference to FIGS. 6 and 7.

FIG. 2 is a diagram illustrating an example of a first mode for initial driving of a display according to various embodiments.

Referring to FIG. 2, the display 115 (or display panel 140) may include a low temperature polycrystalline oxide (LTPO) thin film transistor (TFT). For example, when the display 115 including the LTPO TFT is initially driven, the processor 110 and the display driver circuitry 120 may execute operations illustrated in FIG. 2 according to the first mode.

For example, a power down state (or mode) 211 of the display 115 may be changed or transitioned to a power up state 212 of the display 115 for the initial driving. For example, a change from the power down state 211 to the power up state 212 may be executed based on providing power to the display 115 (or increasing power provided to the display 115) indicated as a state 231.

For example, the power up state 212 of the display 115 may be changed or transitioned to a sleep in state 213 of the display 115. For example, the processor 110 may transmit, to the display driver circuitry 120 of the display 115 within the sleep in state 213, a first command for a sleep out state of the display 115, through the interface 112. For example, the processor 110 may enable periodic transmissions of a pulse signal 203 from the processor 110 to the display driver circuitry 120, as in a state 233, before or while the first command is provided.

For example, the periodic transmissions of the pulse signal 203 may be executed to synchronize timings for displaying on the display panel 140 identified by the processor 110 with timings for displaying on the display panel 140 identified by the display driver circuitry 120.

For example, the pulse signal 203 may be transmitted from the processor 110 to the display driver circuitry 120, based on a period corresponding to a period of a horizontal synchronization signal for the processor 110. For example, the display driver circuitry 120 may synchronize a timing of the horizontal synchronization signal for the display driver circuitry 120 with a timing of the horizontal synchronization signal for the processor 110, based on the period of the pulse signal 203.

For example, the processor 110 may change a waveform (or width) of the pulse signal 203 periodically transmitted from the processor 110 to the display driver circuitry 120, based on an emission synchronization signal 202 for the processor 110. For example, the waveform of the pulse signal 203 transmitted to the display driver circuitry 120 at a start timing of the horizontal synchronization signal for the processor 110 that overlaps with a start timing of the emission synchronization signal 202 for the processor 110 may be a first waveform, the first waveform being different from a second waveform of the pulse signal 203 transmitted to the display driver circuitry 120 at the start timing of the horizontal synchronization signal for the processor 110 that does not overlap with the start timing of the emission synchronization signal 202 for the processor 110. For example, the display driver circuitry 120 may synchronize a timing of an emission synchronization signal for the display driver circuitry 120 with a timing of the emission synchronization signal 202 for the processor 110, based on the first waveform of the pulse signal 203.

Although not illustrated in FIG. 2, the processor 110 may change a waveform (or width) of the pulse signal 203 periodically transmitted from the processor 110 to the display driver circuitry 120, based on a vertical synchronization signal 201 for the processor 110. For example, the waveform of the pulse signal 203 transmitted to the display driver circuitry 120 at the start timing of the horizontal synchronization signal for the processor 110 that overlaps with a start timing of the vertical synchronization signal 201 for the processor 110 may be a third waveform, the third waveform being different from the first waveform and the second waveform of the pulse signal 203 transmitted to the display driver circuitry 120 at the start timing of the horizontal synchronization signal for the processor 110 that does not overlap with the start timing of the vertical synchronization signal 201 for the processor 110. For example, the display driver circuitry 120 may synchronize a timing of the vertical synchronization signal for the display driver circuitry 120 with a timing of the vertical synchronization signal 201 for the processor 110, based on the third waveform of the pulse signal 203.

For example, the sleep in state 213 may be changed or transitioned to the sleep out state based on the first command. For example, a change from the sleep in state 213 to the sleep out state may be executed based on executing boosting 214 of the power provided to the display 115 as indicated by a state 232.

For example, the display 115 may be in a state 215 waiting to obtain synchronization between the emission synchronization signal 202 for the processor 110 and the emission synchronization signal for the display driver circuitry 120, in response to terminating (or completing) of the boosting 214.

For example, the processor 110 may obtain the emission synchronization signal 202 for the processor 110 from a timing 241. A timing (or start timing) of the emission synchronization signal 202 obtained from the timing 241 may be informed to the display driver circuitry 120, based on a change in the waveform of the pulse signal 203. For example, the display driver circuitry 120 may identify the timing of the emission synchronization signal 202 (or may terminate the state 215) based on the change in the waveform of the pulse signal 203 in accordance with the periodic transmissions, and obtain a vertical synchronization signal 204 for the display driver circuitry 120 from the timing 241 aligned with the timing of the emission synchronization signal 202 in accordance with the identification.

For example, the display driver circuitry 120 may execute displaying 216 of at least one initial image of the display panel 140, based on the vertical synchronization signal 204 obtained from the timing 241. The at least one initial image may not be an image transmitted from the processor 110. As a non-limiting example, a refresh rate for displaying 216 of the at least one initial image may be pre-defined within each of the processor 110 and/or the display driver circuitry 120.

For example, the display driver circuitry 120 may execute displaying 217 of a black image based on the vertical synchronization signal 204 obtained from the timing 241 after displaying 216 of the at least one initial image, in response to completing (or terminating) of setting of the display driver circuitry 120. For example, the black image may be an image (an image according to black data) for the initial driving (e.g., an invalid image). For example, the black image may not be an image transmitted from the processor 110. As a non-limiting example, a refresh rate for displaying 217 of the black image may be pre-defined within each of the processor 110 and/or the display driver circuitry 120.

For example, the display driver circuitry 120 may extend the vertical synchronization signal 204 while the display 115 is within a state 218 in which the black image is maintained on the display panel 140 after terminating of the execution of displaying 217 of the black image.

For example, the processor 110 may transmit, to the display driver circuitry 120, through the interface 112, a second command for the display on state of the display 115, based on informing the display driver circuitry 120 of the timing of the emission synchronization signal 202 through the pulse signal 203.

For example, the processor 110 may transmit, based on the emission synchronization signal 202 from a timing 242 (and/or the vertical synchronization signal 201 from the timing 242), a first image to the display driver circuitry 120 through the interface 112, as in a state 234, after providing the second command to the display driver circuitry 120, while the black image is maintained on the display panel 140. For example, the first image may be an image initially transmitted from the processor 110 to the display driver circuitry 120. For example, the display driver circuitry 120 may obtain the vertical synchronization signal 204 from the timing 242, in response to the first image. For example, the display driver circuitry 120 may execute displaying 219 of the first image on the display panel 140, based on the vertical synchronization signal 204 obtained in response to the first image.

As a non-limiting example, the timing 242 of transmitting the first image may be aligned with a period of the vertical synchronization signal 204 from the timing 241. For example, the alignment of the timing 242 may be pre-defined within each of the processor 110 and the display driver circuitry 120. For example, a time length 243 from the timing 241 to the timing 242 may be a multiple of a time interval of the vertical synchronization signal 204.

As a non-limiting example, the timing 242 of transmitting the first image may be aligned with a timing 244 associated with a transmission of the second command, based on the period of the vertical synchronization signal 204. For example, the alignment of the timing 242 may be pre-defined within each of the processor 110 and the display driver circuitry 120. For example, unlike the illustration in FIG. 2, a time length 245 from the timing 244 to the timing 242 may be a multiple of a time interval 249 of the vertical synchronization signal 204.

For example, the processor 110 may transmit, to the display driver circuitry 120 through the interface 112, a second image, as in a state 235, based on the vertical synchronization signal 201 from a timing 246. For example, a time length 247 from the timing 242 to the timing 246 may not be a multiple of the time interval 249 of the vertical synchronization signal 204. For example, a refresh rate for displaying 219 of the first image indicated by the time length 247 may be different from a refresh rate for displaying 217 of the black image. For example, the display driver circuitry 120 may execute displaying 220 of the second image on the display panel 140, based on the vertical synchronization signal 204 from the timing 246.

For example, the processor 110 may transmit, to the display driver circuitry 120 through the interface 112, a third image, as in a state 236, based on the vertical synchronization signal 201 from a timing 248. For example, the display driving circuitry 120 may execute displaying 221 of the third image on the display panel 140, based on the vertical synchronization signal 204 from the timing 248.

FIG. 3 is a diagram illustrating example of a first mode for initial driving of a display according to various embodiments.

Referring to FIG. 3, the display 115 (or display panel 140) may include a low temperature polycrystalline silicon (LTPS) TFT. For example, when the display 115 including the LTPS TFT is initially driven, the processor 110 and the display driver circuitry 120 may execute operations illustrated in FIG. 3 according to the first mode.

For example, a power down state (or mode) 311 of the display 115 may be changed or transitioned to a power up state 312 of the display 115 for the initial driving. For example, a change from the power down state 311 to the power up state 312 may be executed based on providing power to the display 115 (or increasing power provided to the display 115), indicated as a state 331.

For example, the power up state 312 of the display 115 may be changed or transitioned to a sleep in state 313 of the display 115. For example, the processor 110 may transmit, to the display driver circuitry 120 of the display 115 within the sleep in state 313, a first command for a sleep out state of the display 115, through the interface 112. For example, the processor 110 may enable periodic transmissions of a pulse signal 303 (e.g., the pulse signal 203) from the processor 110 to the display driver circuitry 120, as in a state 333, before or while the first command is provided.

For example, the periodic transmissions of the pulse signal 303 may be executed to synchronize timings for displaying on the display panel 140 identified by the processor 110 with timings for displaying on the display panel 140 identified by the display driver circuitry 120.

For example, the pulse signal 303 may be transmitted from the processor 110 to the display driver circuitry 120, based on a period corresponding to a period of a horizontal synchronization signal for the processor 110. For example, the display driver circuitry 120 may synchronize a timing of the horizontal synchronization signal for the display driver circuitry 120 with a timing of the horizontal synchronization signal for the processor 110, based on the period of the pulse signal 303.

For example, the processor 110 may change a waveform (or width) of the pulse signal 303 periodically transmitted from the processor 110 to the display driver circuitry 120, based on an emission synchronization signal 302 for the processor 110. For example, the waveform of the pulse signal 303 transmitted to the display driver circuitry 120 at a start timing of the horizontal synchronization signal for the processor 110 that overlaps with a start timing of the emission synchronization signal 302 may be a first waveform, the first waveform being different from a second waveform of the pulse signal 303 transmitted to the display driver circuitry 120 at a start timing of the horizontal synchronization signal for the processor 110 that does not overlap with the start timing of the emission synchronization signal 302. For example, the display driver circuitry 120 may synchronize a timing of an emission synchronization signal for the display driver circuitry 120 with a timing of the emission synchronization signal 302, based on the first waveform of the pulse signal 303.

Although not illustrated in FIG. 3, the processor 110 may change a waveform (or width) of the pulse signal 303 periodically transmitted from the processor 110 to the display driver circuitry 120, based on a vertical synchronization signal 301 for the processor 110. For example, the waveform of the pulse signal 303 transmitted to the display driver circuitry 120 at a start timing of the horizontal synchronization signal for the processor 110 that overlaps with a start timing of the vertical synchronization signal 301 may be a third waveform, the third waveform being different from the first waveform and the second waveform of the pulse signal 303 transmitted to the display driver circuitry 120 at a start timing of the horizontal synchronization signal for the processor 110 that does not overlap with a start timing of the vertical synchronization signal 301. For example, the display driver circuitry 120 may synchronize a timing of a vertical synchronization signal 304 for the display driver circuitry 120 with a timing of the vertical synchronization signal 201 for the processor 110, based on the third waveform of the pulse signal 303.

For example, the sleep in state 313 may be changed or transitioned to the sleep out state based on the first command. For example, the change from the sleep in state 313 to the sleep out state may be executed based on executing boosting 314 of the power provided to the display 115, as indicated by a state 332.

For example, the display 115 may be in a state 315 waiting to obtain synchronization between the emission synchronization signal 302 and the emission synchronization signal for the display driver circuitry 120, in response to terminating (or completing) of the boosting 314.

For example, the processor 110 may obtain the emission synchronization signal 302 from a timing 341. A timing (or start timing) of the emission synchronization signal 302 obtained from the timing 341 may be informed to the display driver circuitry 120, based on a change in the waveform of the pulse signal 303. For example, the display driver circuitry 120 may identify the timing of the emission synchronization signal 302 (or may terminate the state 315) based on the change in the waveform of the pulse signal 303 in accordance with the periodic transmissions, and obtain the vertical synchronization signal 304 for the display driver circuitry 120 from the timing 341 aligned with the timing of the emission synchronization signal 302 in accordance with the identification.

For example, the display driver circuitry 120 may execute displaying 316 of at least one initial image of the display panel 140, based on the vertical synchronization signal 304 obtained from the timing 341. The at least one initial image may not be an image transmitted from the processor 110. As a non-limiting example, a refresh rate for displaying 316 of the at least one initial image may be pre-defined within each of the processor 110 and/or the display driver circuitry 120.

For example, the display driver circuitry 120 may execute multiple displays of a black image based on a vertical synchronization signal 304 (e.g., vertical synchronization signal 304 at a timing 344) obtained from the timing 341 after displaying 316 of the at least one initial image, in response to completing (or terminating) of setting of the display driver circuitry 120. For example, the multiple displays of the black image may include a first display 317 of the black image and at least one second display 318 of the black image. For example, the black image may be an image for initial driving (an image according to black data) (e.g., an invalid image). For example, the black image may not be an image transmitted from the processor 110. As a non-limiting example, a refresh rate for the first display 317 of the black image and a refresh rate for the at least one second display 318 of the black image may be pre-defined within each of the processor 110 and the display driver circuitry 120. For example, the refresh rate for the first display 317 of the black image and the refresh rate for the at least one second display 318 of the black image may be pre-defined within each of the processor 110 and the display driver circuitry 120, in order to reduce reception from the processor 110 of the first image to be described in greater detail below while one of the multiple displays of the black image is executed.

For example, since a time during which the black image is maintained on the display panel 140 including the LTPS TFT may be shorter than a time during which the black image is maintained on the display panel 140 including the LTPO TFT as described with reference to FIG. 2, although FIG. 3 illustrates multiple displays of the black image, a single display of the black image may also be executed within the electronic device 100.

For example, unlike the example of FIG. 2, the display driver circuitry 120 may maintain obtaining the vertical synchronization signal 304 for the multiple displays of the black image. For example, the display driver circuitry 120 may execute the first display 317 of the black image, and execute the at least one second display 318 of the black image based on the vertical synchronization signal 304 being maintained after the first display 317 of the black image.

For example, the processor 110 may transmit, to the display driver circuitry 120 through the interface 112, a second command for a display-on state of the display 115, based on informing the display driver circuitry 120 of the timing of the emission synchronization signal 302 through the pulse signal 303.

For example, the processor 110 may transmit, to the display driver circuitry 120 through the interface 112, a first image, as in a state 334, based on the emission synchronization signal 302 before a third display of the black image subsequent to the at least one second display 318 is executed. For example, the first image may be transmitted after providing the second command. For example, the first image may be an image initially transmitted from the processor 110 to the display driver circuitry 120. For example, the display driver circuitry 120 may execute displaying 319 of the first image received from the processor 110 on the display panel 140, based on a timing 342 of the vertical synchronization signal 304 maintained after terminating of the execution of the first display 317 of the black image. For example, since the vertical synchronization signal 304 is maintained from the timing 341, the timing 342 of the vertical synchronization signal 304 may be aligned with a timing at which the first image is transmitted from the processor 110 (e.g., the timing 342 of the vertical synchronization signal 301 and/or the timing 342 of the emission synchronization signal 302). For example, a length 343 between the timing 341 and the timing 342 may be a multiple of a time interval of the vertical synchronization signal 304.

For example, the processor 110 may transmit, to the display driver circuitry 120 through the interface 112, a second image, based on the vertical synchronization signal 301 from a timing 346, as in a state 335. For example, a time length 347 from the timing 342 to the timing 346 may be a multiple of a time interval 349 of the vertical synchronization signal 304. For example, a refresh rate for displaying 319 of the first image indicated by the time length 347 may be equal to a refresh rate for each of the first display 317 for the black image and the second display 318 for the black image. However, the disclosure is not limited thereto. For example, a refresh rate for displaying 319 of the first image may be different from a refresh rate of at least a portion of the first display 317 for the black image and the second display 318 for the black image.

For example, the display driver circuitry 120 may execute displaying 320 of the second image on the display panel 140, based on the vertical synchronization signal 304 from the timing 346.

For example, the processor 110 may transmit, to the display driver circuitry 120 through the interface 112, a third image, based on the vertical synchronization signal 301 from a timing 348, as in a state 336. For example, the display driving circuitry 120 may execute displaying 321 of the third image on the display panel 140, based on the vertical synchronization signal 304 from the timing 348.

FIG. 4 is a diagram illustrating an example of a second mode for initial driving of a display according to various embodiments.

Referring to FIG. 4, the display 115 (or display panel 140) may include the LTPO TFT. For example, when the display 115 including the LTPO TFT is initially driven, the processor 110 and the display driver circuitry 120 may execute operations illustrated in FIG. 4 according to the second mode.

The operations illustrated in FIG. 4 may be executed within the electronic device 100 in a state where a signal 405 is enabled, unlike the electronic device 100 executing the operations illustrated in FIGS. 2 and 3, the signal 405 transmitted from the display driver circuitry 120 to the processor 110 and indicating whether to enable or disable the image transmission from the processor 110 to the display driver circuitry 120. For example, in the second mode, the processor 110 may execute a transmission of a first image based further on the signal 405.

For example, a power down state (or mode) 411 of the display 115 may be changed or transitioned to a power up state 412 of the display 115 for the initial driving. For example, the change from the power down state 411 to the power up state 412 may be executed based on providing power to the display 115 (or increasing power provided to the display 115), indicated as a state 431.

For example, the power up state 412 of the display 115 may be changed or transitioned to a sleep in state 413 of the display 115. For example, the processor 110 may transmit, to the display driver circuitry 120 of the display 115 within the sleep in state 413, through the interface 112, a first command for a sleep-out state of the display 115. For example, the processor 110 may enable periodic transmissions of a pulse signal 403 (e.g., the pulse signal 203) from the processor 110 to the display driver circuitry 120, as in a state 433, before or while the first command is provided.

For example, the periodic transmissions of the pulse signal 403 may be executed to synchronize timings for displaying on the display panel 140 identified by the processor 110 with timings for displaying on the display panel 140 identified by the display driver circuitry 120.

For example, the pulse signal 403 may be transmitted from the processor 110 to the display driver circuitry 120, based on a period corresponding to a period of a horizontal synchronization signal for the processor 110. For example, the display driver circuitry 120 may synchronize a timing of the horizontal synchronization signal for the display driver circuitry 120 with a timing of the horizontal synchronization signal for the processor 110, based on the period of the pulse signal 403.

For example, the processor 110 may change a waveform (or width) of the pulse signal 403 periodically transmitted from the processor 110 to the display driver circuitry 120, based on an emission synchronization signal 402 for the processor 110. For example, the waveform of the pulse signal 403 transmitted to the display driver circuitry 120 at a start timing of the horizontal synchronization signal for the processor 110 that overlaps with a start timing of the emission synchronization signal 402 may be a first waveform, the first waveform being different from a second waveform of the pulse signal 403 transmitted to the display driver circuitry 120 at a start timing of the horizontal synchronization signal for the processor 110 that does not overlap with the start timing of the emission synchronization signal 402. For example, the display driver circuitry 120 may synchronize a timing of an emission synchronization signal for the display driver circuitry 120 with a timing of the emission synchronization signal 402, based on the first waveform of the pulse signal 403.

Although not illustrated in FIG. 4, the processor 110 may change a waveform (or width) of the pulse signal 403 periodically transmitted from the processor 110 to the display driver circuitry 120, based on a vertical synchronization signal 401 for the processor 110. For example, the waveform of the pulse signal 403 transmitted to the display driver circuitry 120 at a start timing of the horizontal synchronization signal for the processor 110 that overlaps with a start timing of the vertical synchronization signal 401 may be a third waveform, the third waveform being different from the first waveform and the second waveform of the pulse signal 403 transmitted to the display driver circuitry 120 at a start timing of the horizontal synchronization signal for the processor 110 that does not overlap with the start timing of the vertical synchronization signal 401. For example, the display driver circuitry 120 may synchronize a timing of a vertical synchronization signal 404 for the display driver circuitry 120 with a timing of the vertical synchronization signal 401 for the processor 110, based on the third waveform of the pulse signal 403.

For example, the sleep in state 413 may be changed or transitioned to the sleep out state based on the first command. For example, the change from the sleep in state 413 to the sleep out state may be executed based on executing boosting 414 of power provided to the display 115, as indicated by a state 432.

For example, the display 115 may be in a state 415 waiting to obtain synchronization between the emission synchronization signal 402 and the emission synchronization signal for the display driver circuitry 120, in response to terminating (or completing) of the boosting 414.

For example, the processor 110 may obtain the emission synchronization signal 402 from a timing 441. A timing (or start timing) of the emission synchronization signal 402 obtained from the timing 441 may be informed to the display driver circuitry 120, based on a change in the waveform of the pulse signal 403. For example, the display driver circuitry 120 may identify the timing of the emission synchronization signal 402 (or may terminate the state 415) based on the change in the waveform of the pulse signal 403 in accordance with the periodic transmissions, and obtain the vertical synchronization signal 404 for the display driver circuitry 120 from the timing 441 aligned with the timing of the emission synchronization signal 402 in accordance with the identification.

For example, the display driver circuitry 120 may execute displaying 416 of at least one initial image of the display panel 140, based on the vertical synchronization signal 404 obtained from the timing 441. The at least one initial image may not be an image transmitted from the processor 110.

For example, the display driver circuitry 120 may execute displaying 417 of a black image based on the vertical synchronization signal 404 obtained from the timing 441 after displaying 416 of the at least one initial image, in response to completing (or terminating) of the setting of the display driver circuitry 120. For example, the black image may be an image for the initial driving (an image according to black data) (e.g., an invalid image). For example, the black image may not be an image transmitted from the processor 110.

For example, the display driver circuitry 120 may extend the vertical synchronization signal 404 while the display 115 is in a state 418 in which the black image is maintained on the display panel 140 after terminating of the execution of displaying 417 of the black image.

For example, as indicated by arrow 451, the display driver circuitry 120 may change a state of the signal 405 provided from the display driver circuitry 120 to the processor 110 from a second state indicating to disable the image transmission to a first state indicating to enable the image transmission, in response to terminating of the execution of the display 417 of the black image.

For example, the display driver circuitry 120 may maintain the state of the signal 405 in the first state while the black image is maintained on the display panel 140.

For example, the processor 110 may transmit, to the display driver circuitry 120 through the interface 112, a second command for a display on state of the display 115, based on informing the display driver circuitry 120 of the timing of the emission synchronization signal 402 through the pulse signal 403. As a non-limiting example, the display driver circuitry 120 may change the state of the signal 405 from the second state to the first state, based on the terminating of the execution of displaying 417 of the black image and the second command.

For example, the processor 110 may transmit a first image to the display driver circuitry 120 through the interface 112, based on the emission synchronization signal 402 from a timing 442 (and/or the vertical synchronization signal 401 from the timing 442) while the black image is maintained on the display panel 140, as in a state 434. For example, the processor 110 may transmit the first image to the display driver circuitry 120 through the interface 112, based on the signal 405 within the first state, as indicated by arrow 452. For example, the first image may be an image initially transmitted from the processor 110 to the display driver circuitry 120.

For example, the display driver circuitry 120 may receive the first image transmitted from the processor 110 based on the signal 405 within the first state. For example, the display driver circuitry 120 may obtain the vertical synchronization signal 404 from the timing 442 in response to the first image. For example, the display driver circuitry 120 may execute displaying 419 of the first image on the display panel 140, based on the vertical synchronization signal 404 from the timing 442. For example, the display driver circuitry 120 may change the state of the signal 405 from the first state to the second state, in response to the reception of the first image, as indicated by arrow 453. For example, the display driver circuitry 120 may maintain the state of the signal 405 in the second state.

For example, since a transmission timing (e.g., the timing 442) of the first image is identified by the processor 110 based on the signal 405 within the first state, a time length 443 between the timing 441 and the timing 442 may not be a multiple of a time interval 449 for displaying 417 of the black image. As a non-limiting example, the time length 443 may be a multiple of the time interval 449.

For example, the display driver circuitry 120 may change the state of the signal 405 from the second state to the first state, in response to terminating (or completing) of the execution of displaying 419 of the first image, as indicated by arrow 454.

For example, the processor 110 may transmit the second image to the display driver circuitry 120 through the interface 112, based on the vertical synchronization signal 401 (or the emission synchronization signal 402) from a timing 446, as in a state 435. For example, the processor 110 may transmit the second image to the display driver circuitry 120 through the interface 112, based on the signal 405 within the first state, as indicated by arrow 455.

For example, the display driver circuitry 120 may execute displaying 420 of the second image on the display panel 140, based on the vertical synchronization signal 404 from the timing 446, in response to the second image transmitted from the processor 110 based on the signal 405 within the first state.

For example, the display driver circuitry 120 may change the state of the signal 405 from the first state to the second state, in response to the reception of the second image, as indicated by arrow 456. For example, the display driver circuitry 120 may maintain the state of the signal 405 in the second state until terminating of the execution of displaying 420 of the second image (or terminating (or completing) of scanning of the second image).

For example, the display driver circuitry 120 may change the state of the signal 405 from the second state to the first state, in response to terminating (or completing) of the execution of displaying 420 of the second image, as indicated by arrow 457.

For example, the processor 110 may transmit a third image to the display driver circuitry 120 through the interface 112, based on the vertical synchronization signal 401 (or the emission synchronization signal 402) from a timing 448, as in a state 436. For example, the processor 110 may transmit the third image to the display driver circuitry 120 through the interface 112, based on the signal 405 within the first state, as indicated by arrow 458.

For example, the display driver circuitry 120 may execute displaying 421 of the third image on the display panel 140, based on the vertical synchronization signal 404 from the timing 448, in response to the third image transmitted from the processor 110 based on the signal 405 within the first state.

For example, the display driver circuitry 120 may change the state of the signal 405 from the first state to the second state, in response to the reception of the third image, as indicated by arrow 459. For example, the display driver circuitry 120 may maintain the state of the signal 405 in the second state until terminating of the execution of displaying 421 of the third image (or terminating (or completing) of scanning of the third image).

For example, the display driver circuitry 120 may change the state of the signal 405 from the second state to the first state, in response to terminating (or completing) of the execution of displaying 421 of the third image, as indicated by arrow 460.

FIG. 5 is a diagram illustrating example of a second mode for initial driving of a display according to various embodiments.

Referring to FIG. 5, the display 115 (or the display panel 140) may include the LTPS TFT. For example, when the display 115 including the LTPS TFT is initially driven, the processor 110 and the display driver circuitry 120 may execute operations illustrated in FIG. 5 according to the second mode.

The operations illustrated in FIG. 5 may be executed within the electronic device 100 within a state where a signal 505 is enabled, unlike the electronic device 100 executing the operations illustrated in FIGS. 2 and 3, the signal 505 transmitted from the display driver circuitry 120 to the processor 110 and indicating a timing of the image transmission from the processor 110 to the display driver circuitry 120. For example, in the second mode, the processor 110 may execute a transmission of a first image based further on the signal 505.

For example, a power down state (or mode) 511 of the display 115 may be changed or transitioned to a power up state 512 of the display 115 for the initial driving. For example, the change from the power down state 511 to the power up state 512 may be executed based on providing power to the display 115 (or increasing power provided to the display 115), indicated as a state 531.

For example, the power up state 512 of the display 115 may be changed or transitioned to a sleep in state 513 of the display 115. For example, the processor 110 may transmit, to the display driver circuitry 120 of the display 115 within the sleep-in state 513 through the interface 112, a first command for a sleep out state of the display 115. For example, the processor 110 may enable periodic transmissions of a pulse signal 503 (e.g., the pulse signal 203) from the processor 110 to the display driver circuitry 120, as in a state 533, before or while the first command is provided.

For example, the periodic transmissions of the pulse signal 503 may be executed to synchronize timings for displaying on the display panel 140 identified by the processor 110 with timings for displaying on the display panel 140 identified by the display driver circuitry 120.

For example, the pulse signal 503 may be transmitted from the processor 110 to the display driver circuitry 120, based on a period corresponding to a period of a horizontal synchronization signal for the processor 110. For example, the display driver circuitry 120 may synchronize a timing of the horizontal synchronization signal for the display driver circuitry 120 with a timing of the horizontal synchronization signal for the processor 110, based on the period of the pulse signal 503.

For example, the processor 110 may change a waveform (or width) of the pulse signal 503 periodically transmitted from the processor 110 to the display driver circuitry 120, based on an emission synchronization signal 502 for the processor 110. For example, the waveform of the pulse signal 503 transmitted to the display driver circuitry 120 at a start timing of the horizontal synchronization signal for the processor 110 that overlaps with a start timing of the emission synchronization signal 502 may be a first waveform, the first waveform being different from a second waveform of the pulse signal 503 transmitted to the display driver circuitry 120 at a start timing of the horizontal synchronization signal for the processor 110 that does not overlap with the start timing of the emission synchronization signal 502. For example, the display driver circuitry 120 may synchronize a timing of an emission synchronization signal for the display driver circuitry 120 with a timing of the emission synchronization signal 502, based on the first waveform of the pulse signal 503.

Although not illustrated in FIG. 5, the processor 110 may change a waveform (or width) of the pulse signal 503 periodically transmitted from the processor 110 to the display driver circuitry 120, based on a vertical synchronization signal 501 for the processor 110. For example, the waveform of the pulse signal 503 transmitted to the display driver circuitry 120 at a start timing of the horizontal synchronization signal for the processor 110 that overlaps with a start timing of the vertical synchronization signal 501 may be a third waveform, the third waveform being different from the first waveform and the second waveform of the pulse signal 503 transmitted to the display driver circuitry 120 at a start timing of the horizontal synchronization signal for the processor 110 that does not overlap with the start timing of the vertical synchronization signal 501. For example, the display driver circuitry 120 may synchronize a timing of the vertical synchronization signal 504 for the display driver circuitry 120 with a timing of the vertical synchronization signal 501, based on the third waveform of the pulse signal 503.

For example, the sleep in state 513 may be changed or transitioned to the sleep out state based on the first command. For example, the change from the sleep in state 513 to the sleep out state may be executed based on executing boosting 514 of power provided to the display 115, as indicated by a state 532.

For example, the display 115 may be in a state 515 waiting to obtain synchronization between the emission synchronization signal 502 and the emission synchronization signal for the display driver circuitry 120, in response to terminating (or completing) of the boosting 514.

For example, the processor 110 may obtain the emission synchronization signal 502 from a timing 541. A timing (or start timing) of the emission synchronization signal 502 obtained from the timing 541 may be informed to the display driver circuitry 120, based on a change in the waveform of the pulse signal 503. For example, the display driver circuitry 120 may identify the timing of the emission synchronization signal 502 (or may terminate the state 515) based on the change in the waveform of the pulse signal 503 in accordance with the periodic transmissions, and obtain the vertical synchronization signal 504 for the display driver circuitry 120 from the timing 541 aligned with the timing of the emission synchronization signal 502, in accordance with the identification.

For example, the display driver circuitry 120 may execute displaying 516 of at least one initial image of the display panel 140, based on the vertical synchronization signal 504 obtained from the timing 541. The at least one initial image may not be an image transmitted from the processor 110. As a non-limiting example, a refresh rate for displaying 516 of the at least one initial image may be pre-defined within the display driver circuitry 120. As a non-limiting example, a refresh rate for displaying 516 of the at least one initial image may be pre-defined within the processor 110.

For example, the display driver circuitry 120 may execute multiple displays of a black image based on a vertical synchronization signal 504 (e.g., the vertical synchronization signal 504 at a timing 544) obtained from the timing 541 after displaying 516 of the at least one initial image, in response to completing (or terminating) of setting of the display driver circuitry 120. For example, the multiple displays of the black image may include a first display 517 of the black image and at least one second display 518 of the black image. For example, the black image may be an image for the initial driving (an image according to black data) (e.g., an invalid image). For example, the black image may not be an image transmitted from the processor 110. For example, the display driver circuitry 120 may execute the first display 517 of the black image and the second display 518 of the black image, based on the vertical synchronization signal 504 maintained from the timing 541.

As a non-limiting example, a refresh rate for the first display 517 of the black image and a refresh rate for the at least one second display 518 of the black image may be pre-defined within the display driver circuitry 120. As a non-limiting example, the refresh rate for the first display 517 of the black image and the refresh rate for the at least one second display 518 of the black image may be pre-defined within the processor 110.

For example, since a time during which the black image is maintained on the display panel 140 including the LTPS TFT may be shorter than a time during which the black image is maintained on the display panel 140 including the LTPO TFT as described in the descriptions of FIGS. 2 and 4, although FIG. 5 illustrates the multiple displays of the black image, a single display of the black image may also be executed within the electronic device 100.

For example, the display driver circuitry 120 may provide or transmit, to the processor 110, a signal 505 indicating a timing capable of executing the image transmission, in response to terminating (or completing) of execution of each of the multiple displays of the black image. For example, the display driver circuitry 120 may provide, to the processor 110, the signal 505, in response to terminating of execution of the first display 517 of the black image, as indicated by arrow 551. For example, the signal 505 may indicate a timing 553 of the emission synchronization signal 502 capable of executing the image transmission. For example, a timing 552 at which the signal 505 is provided may be prior to the timing 553. For example, the signal 505 may be provided to the processor 110 at the timing 552 prior to the timing 553 capable of initiating execution of displaying of the black image (e.g., at least one second display 518 of the black image) subsequent to the first display 517 of the black image.

For example, the display driver circuitry 120 may provide the signal 505 to the processor 110, in response to terminating of execution of at least one second display 518 of the black image, as indicated by arrow 553. For example, the signal 505 may indicate a timing 542 of the emission synchronization signal 502 capable of executing the image transmission. For example, a timing 554 at which the signal 505 is provided may be prior to the timing 542. For example, the signal 505 may be provided to the processor 110 at the timing 554 that is prior to the timing 542 capable of initiating execution of a third display of the black image, subsequent to the at least one second display 518 of the black image.

For example, the processor 110 may transmit, to the display driver circuitry 120 through the interface 112, a second command for a display on state of the display 115, based on informing the display driver circuitry 120 of the timing of the emission synchronization signal 502 through the pulse signal 503.

For example, the processor 110 may transmit an image to the display driver circuitry 120, based on a timing (e.g., the timing 553 and the timing 542) of the image transmission indicated by the signal 505. As a non-limiting example, transmitting the image may be executed after transmitting the second command. As a non-limiting example, the display driver circuitry 120 may initiate providing the signal 505, in response to the second command.

For example, the processor 110 may transmit, to the display driver circuitry 120 through the interface 112, a first image, as in a state 534, based on the emission synchronization signal 502 before the third display of the black image is executed. For example, the processor 110 may transmit, to the display driver circuitry 120 through the interface 112, the first image, at the timing 542 indicated by the signal 505. For example, the first image may be an image initially transmitted from the processor 110 to the display driver circuitry 120. For example, since the timing 542 for a transmission of the first image is indicated by the signal 505 from the display driver circuitry 120, the occurrence of a collision between the first image and the black image may be reduced. As a non-limiting example, the timing 542 of the transmission of the first image is indicated by the signal 505, but when a time interval 549 for the first display 517 of the black image (and/or the at least one second display 518 of the black image) is fixed, a time length 543 from the timing 541 to the timing 542 may consequently be a multiple of the time interval 549.

For example, the display driver circuitry 120 may execute displaying 519 of the first image. For example, the display driver circuitry 120 may provide or transmit, to the processor 110, the signal 505 indicating a timing capable of executing the image transmission, in response to terminating (or completing) of the execution of displaying 519 of the first image, as indicated by arrow 555. For example, the signal 505 may indicate a timing 546 of the emission synchronization signal 502. For example, a timing 556 at which the signal 505 is provided may be prior to the timing 546. For example, the signal 505 may be provided to the processor 110 at the timing 556 prior to the timing 546 capable of initiating execution of displaying of an image subsequent to the first image (e.g., displaying of the second image 520).

For example, the processor 110 may transmit, to the display driver circuitry 120 through the interface 112, the second image, as in a state 535, based on the emission synchronization signal 502 from the timing 546 indicated by the signal 505. For example, the display driver circuitry 120 may execute displaying 520 of the second image. For example, the display driver circuitry 120 may provide or transmit, to the processor 110, the signal 505 indicating a timing capable of executing the image transmission, in response to terminating (or completing) of the execution of displaying 520 of the second image, as indicated by arrow 557. For example, the signal 505 may indicate a timing 548 of the emission synchronization signal 502. For example, a timing 558 at which the signal 505 is provided may be prior to the timing 548. For example, the signal 505 may be provided to the processor 110 at a timing 558 prior to the timing 548 capable of initiating execution of displaying of an image subsequent to the second image (e.g., displaying of the third image 521).

For example, the processor 110 may transmit to the display driver circuitry 120 through the interface 112, the third image, as in a state 536, based on the emission synchronization signal 502 from the timing 548 indicated by the signal 505. For example, the display driver circuitry 120 may execute displaying 521 of the third image. For example, the display driver circuitry 120 may provide or transmit, to the processor 110, the signal 505 indicating a timing capable of executing the image transmission, in response to terminating (or completing) of the execution of displaying 521 of the third image, as indicated by arrow 559. For example, the signal 505 may indicate a timing 550 of the emission synchronization signal 502. For example, a timing 560 at which the signal 505 is provided may be prior to the timing 550. For example, the signal 505 may be provided to the processor 110 at the timing 560 prior to the timing 550 capable of initiating execution of displaying of an image subsequent to the third image.

FIG. 6 is a diagram illustrating an example of a third mode for initial driving of a display according to various embodiments.

Referring to FIG. 6, the display 115 (or the display panel 140) may include the LTPO TFT. For example, when the display 115 including the LTPO TFT is initially driven, the processor 110 and the display driver circuitry 120 may execute operations illustrated in FIG. 6 according to the third mode.

The operations illustrated in FIG. 6 may be executed within the electronic device 100 within a state in which a signal 605 is enabled, unlike the electronic device 100 executing the operations illustrated in FIGS. 2 and 3, the signal 605 transmitted from the display driver circuitry 120 to the processor 110 and indicating whether to enable or disable the image transmission from the processor 110 to the display driver circuitry 120. For example, within the third mode, unlike FIG. 4, the processor 110 may initiate identifying a state of the signal 605 after a transmission of an initial image (e.g., a black image described in the description of FIG. 6) to the display driver circuitry 120.

For example, a power down state (or mode) 611 of the display 115 may be changed or transitioned to a power up state 612 of the display 115 for the initial driving. For example, a change from the power down state 611 to the power up state 612 may be executed based on providing power to the display 115 (or increasing power provided to the display 115), indicated as a state 631.

For example, the power up state 612 of the display 115 may be changed or transitioned to a sleep in state 613 of the display 115. For example, the processor 110 may transmit, to the display driver circuitry 120 of the display 115 within the sleep in state 613, through the interface 112, a first command for a sleep-out state of the display 115. For example, the processor 110 may enable periodic transmissions of a pulse signal 603 from the processor 110 to the display driver circuitry 120, as in a state 633, before or while the first command is provided.

For example, the periodic transmissions of the pulse signal 603 may be executed to synchronize timings for displaying on the display panel 140 identified by the processor 110 with timings for displaying on the display panel 140 identified by the display driver circuitry 120.

For example, the pulse signal 603 may be transmitted from the processor 110 to the display driver circuitry 120, based on a period corresponding to a period of a horizontal synchronization signal for the processor 110. For example, the display driver circuitry 120 may synchronize a timing of the horizontal synchronization signal for the display driver circuitry 120 with a timing of the horizontal synchronization signal for the processor 110, based on the period of the pulse signal 603.

For example, the processor 110 may change a waveform (or width) of the pulse signal 603 periodically transmitted from the processor 110 to the display driver circuitry 120, based on an emission synchronization signal 602 for the processor 110. For example, the waveform of the pulse signal 603 transmitted to the display driver circuitry 120 at a start timing of the horizontal synchronization signal for the processor 110 that overlaps with a start timing of the emission synchronization signal 602 may be a first waveform, the first waveform being different from a second waveform of the pulse signal 603 transmitted to the display driver circuitry 120 at a start timing of the horizontal synchronization signal for the processor 110 that does not overlap with the start timing of the emission synchronization signal 602. For example, the display driver circuitry 120 may synchronize a timing of an emission synchronization signal for the display driver circuitry 120 with a timing of the emission synchronization signal 602, based on the first waveform of the pulse signal 603.

Although not illustrated in FIG. 6, the processor 110 may change the waveform (or width) of the pulse signal 603 periodically transmitted from the processor 110 to the display driver circuitry 120, based on a vertical synchronization signal 601 for the processor 110. For example, the waveform of the pulse signal 603 transmitted to the display driver circuitry 120 at a start timing of the horizontal synchronization signal for the processor 110 that overlaps with a start timing of the vertical synchronization signal 601 may be a third waveform, the third waveform being different from the first waveform and the second waveform of the pulse signal 603 transmitted to the display driver circuitry 120 at a start timing of the horizontal synchronization signal for the processor 110 that does not overlap with the start timing of the vertical synchronization signal 601. For example, the display driver circuitry 120 may synchronize a timing of a vertical synchronization signal 604 for the display driver circuitry 120 with a timing of the vertical synchronization signal 601 for the processor 110, based on the third waveform of the pulse signal 603.

For example, the sleep in state 613 may be changed or transitioned to the sleep out state, based on the first command. For example, the change from the sleep in state 613 to the sleep out state may be executed based on executing boosting 614 of power provided to the display 115, as indicated by a state 632.

For example, the display 115 may be in a state 615 waiting to obtain synchronization between the emission synchronization signal 602 and the emission synchronization signal for the display driver circuitry 120, in response to terminating (or completing) of the boosting 614.

For example, the processor 110 may obtain the emission synchronization signal 602 from a timing 641. A timing (or start timing) of the emission synchronization signal 602 obtained from the timing 641 may be informed to the display driver circuitry 120 based on a change in the waveform of the pulse signal 603. For example, the display driver circuitry 120 may identify the timing of the emission synchronization signal 602 (or terminate the state 615) based on the change in the waveform of the pulse signal 603 in accordance with the periodic transmissions, and obtain the vertical synchronization signal 604 for the display driver circuitry 120 from the timing 641 aligned with the timing of the emission synchronization signal 602 in accordance with the identification.

For example, the display driver circuitry 120 may execute displaying 616 of at least one initial image of the display panel 140, based on the vertical synchronization signal 604 obtained from the timing 641. The at least one initial image may not be an image transmitted from the processor 110.

For example, the display driver circuitry 120 may execute displaying 617 of a black image based on the vertical synchronization signal 604 obtained from the timing 641 after displaying 616 of the at least one initial image, in response to completing (or terminating) of setting of the display driver circuitry 120. For example, the black image may be an image for the initial driving (an image according to black data) (e.g., an invalid image). For example, the black image may not be an image transmitted from the processor 110.

For example, the display driver circuitry 120 may extend the vertical synchronization signal 604 while the display 115 is in a state 618 in which the black image is maintained on the display panel 140 after terminating of execution of displaying 617 of the black image.

For example, the display driver circuitry 120 may change a state of the signal 605 provided from the display driver circuitry 120 to the processor 110 from a second state indicating to disable the image transmission to a first state indicating to enable the image transmission, in response to terminating of the execution of displaying 617 of the black image, as indicated by arrow 651. For example, the change from the second state to the first state and the signal 605 within the first state may not be processed by the processor 110. For example, the processor 110 may execute the image transmission, independently of the change from the second state to the first state and the signal 605 within the first state. For example, unlike the example of FIG. 4, the processor 110 may initiate identifying the state of the signal 605, based on initially transmitting an image (e.g., a black image to be described with reference to FIG. 6) to the display driver circuitry 120.

For example, the display driver circuitry 120 may maintain the state of the signal 605 in the first state while the black image is maintained on the display panel 140. For example, the display driver circuitry 120 may extend the vertical synchronization signal 604 while the black image is maintained on the display panel 140.

For example, the processor 110 may transmit, to the display driver circuitry 120 through the interface 112, a second command for the display on state of the display 115, based on informing the display driver circuitry 120 of the timing of the emission synchronization signal 602 through the pulse signal 603. As a non-limiting example, the display driver circuitry 120 may change the state of the signal 605 from the second state to the first state, based on terminating of the execution of displaying 617 of the black image and the second command.

For example, the processor 110 may transmit, to the display driver circuitry 120 through the interface 112, the black image, based on the emission synchronization signal 602 from a timing 642 (and/or the vertical synchronization signal 601 from the timing 642) while the black image is maintained on the display panel 140, as in a state 634. For example, the black image may be transmitted after the second command is provided. For example, the black image may be an image initially transmitted from the processor 110 to the display driver circuitry 120. For example, the black image may be transmitted from the timing 642, independently of whether the signal 605 is within the first state. For example, the processor 110 may execute a transmission of the black image based on a timing (e.g., the timing 642) identified by the processor 110. For example, the processor 110 may initiate identifying the state of the signal 605 after transmitting the black image.

For example, the display driver circuitry 120 may receive the black image. For example, the display driver circuitry 120 may execute displaying 619 of the black image on the display panel 140, based on the vertical synchronization signal 604 from the timing 642 obtained in response to the black image. For example, the display driver circuitry 120 may change the state of the signal 605 from the first state to the second state, in response to the reception of the black image, as indicated by arrow 653. For example, the display driver circuitry 120 may maintain the state of the signal 605 in the second state, until terminating of the execution of displaying 619 of the black image (or terminating (or completing) of scanning of the black image).

For example, since a transmission timing (e.g., the timing 642) of the black image is identified by the processor 110 independently of the state of the signal 605, a time length 643 from the timing 641 to the timing 642 may not be a multiple of a time interval 649 for displaying 617 of the black image.

For example, the display driver circuitry 120 may change the state of the signal 605 from the second state to the first state, in response to terminating (or completing) of the execution of displaying 619 of the black image, as indicated by arrow 654.

For example, the black image from the processor 110 may be received while displaying of the black image is executed by the display driver circuitry 120. For example, the display driver circuitry 120 may ignore the black image received from the processor 110 while the black image is displayed by the display driver circuitry 120. For example, the display driver circuitry 120 may ignore the black image from the processor 110, and change the state of the signal 605 from the second state to the first state, in response to terminating (or completing) of displaying of the black image executed by the display driver circuitry 120. For another example, the display driver circuitry 120 may receive the black image from the processor 110. For example, since the black image received from the processor 110 is equal to the black image displayed by the display driver circuitry 120, the display driver circuitry 120 may receive the black image from the processor 110 and change the state of the signal 605 from the second state to the first state, based at least in part on terminating (or completing) of scanning of the black image received from the processor 110. However, the disclosure is not limited thereto.

For example, the processor 110 may transmit, to the display driver circuitry 120 through the interface 112, a first image, based on the emission synchronization signal 602 from a timing 646 (or the vertical synchronization signal 601 from the timing 646), as in a state 635. For example, the first image may be transmitted from the processor 110 to the display driver circuitry 120 through the interface 112, based on the signal 605 in the first state changed from the second state, as indicated by arrow 655.

For example, in response to the first image transmitted from the processor 110 based on the signal 605 within the first state, the display driver circuitry 120 may execute displaying 620 of the first image on the display panel 140, based on the vertical synchronization signal 604 from the timing 646.

For example, the display driver circuitry 120 may change the state of the signal 605 from the first state to the second state, in response to the reception of the first image, as indicated by arrow 656. For example, the display driver circuitry 120 may maintain the state of the signal 605 in the second state, until terminating of the execution of displaying 620 of the first image (or terminating (or completing) of scanning of the second image).

For example, the display driver circuitry 120 may change the state of the signal 605 from the second state to the first state, in response to terminating (or completing) of the execution of displaying 620 of the first image, as indicated by arrow 657.

For example, the processor 110 may transmit, to the display driver circuitry 120 through the interface 112, a second image, based on the vertical synchronization signal 601 (or the emission synchronization signal 602) from a timing 648, as in a state 636. For example, the processor 110 may transmit, to the display driver circuitry 120 through the interface 112, the second image, based on the signal 605 within the first state, as indicated by arrow 658.

For example, in response to the second image transmitted from the processor 110 based on the signal 605 within the first state, the display driver circuitry 120 may execute displaying 621 of the second image on the display panel 140, based on the vertical synchronization signal 604 from the timing 648.

For example, the display driver circuitry 120 may change the state of the signal 605 from the first state to the second state, in response to the reception of the second image, as indicated by arrow 659. For example, the display driver circuitry 120 may maintain the state of the signal 605 in the second state until terminating of the execution of displaying 621 of the second image (or terminating (or completing) of scanning of the second image).

For example, the display driver circuitry 120 may change the state of the signal 605 from the second state to the first state, in response to terminating (or completing) of the execution of displaying 621 of the second image, as indicated by arrow 660.

FIG. 7 is a diagram illustrating an example of a third mode for initial driving of a display according to various embodiments.

Referring to FIG. 7, the display 115 (or the display panel 140) may include the LTPS TFT. For example, when the display 115 including the LTPS TFT is initially driven, the processor 110 and the display driver circuitry 120 may execute operations illustrated in FIG. 7 according to the third mode.

The operations illustrated in FIG. 7 may be executed within the electronic device 100 within a state in which a signal 705 is enabled, unlike the electronic device 100 executing the operations illustrated in FIGS. 2 and 3, the signal 705 transmitted from the display driver circuitry 120 to the processor 110 and indicating a timing of the image transmission from the processor 110 to the display driver circuitry 120. For example, unlike FIG. 5, in the third mode, the processor 110 may initiate identifying a state of the signal 705, after transmitting an initial image (e.g., a black image to be described in the description of FIG. 7) to the display driver circuitry 120.

For example, a power down state (or mode) 711 of the display 115 may be changed or transitioned to a power up state 712 of the display 115 for the initial driving. For example, the change from the power down state 711 to the power up state 712 may be executed based on providing power to the display 115 (or increasing power provided to the display 115) as indicated by a state 731.

For example, the power up state 712 of the display 115 may be changed or transitioned to a sleep in state 713 of the display 115. For example, the processor 110 may transmit, to the display driver circuitry 120 of the display 115 within the sleep in state 713, through the interface 112, a first command for the sleep out state of the display 115. For example, the processor 110 may enable periodic transmissions of a pulse signal 703 (e.g., the pulse signal 203) from the processor 110 to the display driver circuitry 120, as in a state 733, before or while the first command is provided.

For example, the periodic transmissions of the pulse signal 703 may be executed to synchronize timings for displaying on the display panel 140 identified by the processor 110 with timings for displaying on the display panel 140 identified by the display driver circuitry 120.

For example, the pulse signal 703 may be transmitted from the processor 110 to the display driver circuitry 120, based on a period corresponding to a period of a horizontal synchronization signal for the processor 110. For example, the display driver circuitry 120 may synchronize a timing of the horizontal synchronization signal for the display driver circuitry 120 with a timing of the horizontal synchronization signal for the processor 110, based on the period of the pulse signal 703.

For example, the processor 110 may change a waveform (or width) of the pulse signal 703 periodically transmitted from the processor 110 to the display driver circuitry 120, based on an emission synchronization signal 702 for the processor 110. For example, a waveform of the pulse signal 703 transmitted to the display driver circuitry 120 at a start timing of the horizontal synchronization signal for the processor 110 that overlaps with a start timing of the emission synchronization signal 702 may be a first waveform, the first waveform being different from a second waveform of the pulse signal 703 transmitted to the display driver circuitry 120 at a start timing of the horizontal synchronization signal for the processor 110 that does not overlap with the start timing of the emission synchronization signal 702. For example, the display driver circuitry 120 may synchronize a timing of an emission synchronization signal for the display driver circuitry 120 with a timing of the emission synchronization signal 702, based on the first waveform of the pulse signal 703.

Although not illustrated in FIG. 7, the processor 110 may change a waveform (or width) of the pulse signal 703 periodically transmitted from the processor 110 to the display driver circuitry 120, based on a vertical synchronization signal 701 for the processor 110. For example, the waveform of the pulse signal 703 transmitted to the display driver circuitry 120 at a start timing of the horizontal synchronization signal for the processor 110 that overlaps with a start timing of the vertical synchronization signal 701 may be a third waveform, the third waveform being different from the first waveform and the second waveform of the pulse signal 703 transmitted to the display driver circuitry 120 at a start timing of the horizontal synchronization signal for the processor 110 that does not overlap with the start timing of the vertical synchronization signal 701. For example, the display driver circuitry 120 may synchronize a timing of a vertical synchronization signal 704 for the display driver circuitry 120 with a timing of the vertical synchronization signal 701, based on the third waveform of the pulse signal 703.

For example, the sleep in state 713 may be changed or transitioned to the sleep out state based on the first command. For example, the change from the sleep in state 713 to the sleep out state may be executed, based on executing boosting 714 of power provided to the display 115, as indicated by a state 732.

For example, the display 115 may be in a state 715 waiting to obtain synchronization between the emission synchronization signal 702 and the emission synchronization signal for the display driver circuitry 120, in response to terminating (or completing) of boosting 714.

For example, the processor 110 may obtain the emission synchronization signal 702 from a timing 741. A timing (or start timing) of the emission synchronization signal 702 obtained from the timing 741 may be informed to the display driver circuitry 120, based on a change in the waveform of the pulse signal 703. For example, the display driver circuitry 120 may identify the timing of the emission synchronization signal 702 (or terminate the state 715) based on the change in the waveform of the pulse signal 703 in accordance with the periodic transmissions, and obtain the vertical synchronization signal 704 for the display driver circuitry 120 from the timing 741 aligned with the timing of the emission synchronization signal 702, in accordance with the identification.

For example, the display driver circuitry 120 may execute displaying 716 of at least one initial image of the display panel 140, based on the vertical synchronization signal 704 obtained from the timing 741. The at least one initial image may not be an image transmitted from the processor 110. As a non-limiting example, a refresh rate for displaying 716 of the at least one initial image may be pre-defined within the display driver circuitry 120. As a non-limiting example, the refresh rate for displaying 716 of the at least one initial image may be pre-defined within the processor 110.

For example, the display driver circuitry 120 may execute multiple displays of a black image based on the vertical synchronization signal 704 (e.g., the vertical synchronization signal 704 at a timing 744) obtained from the timing 741 after displaying 716 of the at least one initial image, in response to completing (or terminating) of setting of the display driver circuitry 120. For example, the multiple displays of the black image may include a first display 717 of the black image, a second display 718 of the black image, and a third display 719 of the black image. For example, the black image may be an image for the initial driving (an image according to black data) (e.g., an invalid image). For example, the black image may not be an image transmitted from the processor 110. For example, the display driver circuitry 120 may execute, based on the vertical synchronization signal 704 obtained from the timing 744, the first display 717 of the black image, execute the second display 718 of the black image after the first display 717 of the black image, and execute the third display 719 of the black image after the second display 718 of the black image.

As a non-limiting example, a refresh rate for the first display 717 of the black image, a refresh rate for the second display 718 of the black image, and a refresh rate for the third display 719 of the black image may be pre-defined within the display driver circuitry 120. As a non-limiting example, the refresh rate for the first display 717 of the black image, the refresh rate for the second display 718 of the black image, and the refresh rate for the third display 719 of the black image may be pre-defined within the processor 110.

For example, since a time during which the black image is maintained on the display panel 140 including the LTPS TFT may be shorter than a time during which the black image is maintained on the display panel 140 including the LTPO TFT described with reference to FIGS. 2, 4, and 6, although FIG. 7 illustrates the multiple displays of the black image, a single display of the black image may also be executed within the electronic device 100.

For example, the display driver circuitry 120 may provide or transmit, to the processor 110, a signal 705 indicating a timing capable of executing the image transmission, in response to terminating (or completing) of execution of each of the multiple displays of the black image. For example, the display driver circuitry 120 may provide the signal 705 to the processor 110, in response to terminating of the execution of the first display 717 of the black image, as indicated by arrow 751. For example, the signal 705 may not be identified by the processor 110, or the processor 110 may operate independently of the signal 705. For example, the display driver circuitry 120 may provide the signal 705 to the processor 110, in response to the terminating of the execution of the second display 718 of the black image, as indicated by arrow 753. For example, the signal 705 may not be identified by the processor 110, or the processor 110 may operate independently of the signal 705.

For example, the processor 110 may transmit, to the display driver circuitry 120 through the interface 112, a second command for a display on state of the display 115, based on informing the display driver circuitry 120 of the timing of the emission synchronization signal 702 through the pulse signal 703. As a non-limiting example, the display driver circuitry 120 may initiate providing the signal 705, based on terminating of the execution of the display 717 of the black image and the second command.

For example, the processor 110 may transmit, to the display driver circuitry 120 through the interface 112, the black image, based on the emission synchronization signal 702 from the timing 742 (and/or the vertical synchronization signal 701 from the timing 742), as in a state 734. For example, the black image may be transmitted after the second command is provided. For example, the black image may be an image initially transmitted from the processor 110 to the display driver circuitry 120. For example, the black image may be transmitted from the timing 742 independently of whether the signal 705 is obtained. For example, the processor 110 may execute a transmission of the black image, based on a timing (e.g., the timing 742) identified by the processor 110. For example, the processor 110 may initiate identifying the signal 705 after transmitting the black image.

For example, since the transmission timing (e.g., the timing 742) of the black image is identified by the processor 110 independently of the state of the signal 705, a time length 743 from the timing 741 to the timing 742 may not be a multiple of a time interval 749 for displaying 717 of the black image.

For example, the display driver circuitry 120 may receive the black image. For example, the display driver circuitry 120 may receive the black image from the processor 110 while executing the third display 719 of the black image. For example, the display driver circuitry 120 may execute scanning of the black image from the processor 110. For example, the display driver circuitry 120 may obtain the vertical synchronization signal 704 according to the black image received from the processor 110, as indicated by arrow 790. For example, in response to the terminating (or completing) of displaying 720 of the black image from the processor 110, the display driver circuitry 120 may provide or transmit, to the processor 110, the signal 705 indicating a timing capable of executing the image transmission, as indicated by arrow 755. For example, the signal 705 may indicate a timing 746 of the emission synchronization signal 702. For example, a timing 756 at which the signal 705 is provided may be prior to the timing 746. For example, the signal 705 may be provided to the processor 110 at the timing 756 prior to the timing 746 capable of initiating execution of displaying (e.g., displaying 721 of the first image) of an image subsequent to the black image.

For example, the processor 110 may transmit, to the display driver circuitry 120 through the interface 112, the first image, based on the emission synchronization signal 702 from the timing 746 indicated by the signal 705, as in a state 735. For example, the display driver circuitry 120 may execute displaying 721 of the first image. For example, the display driver circuitry 120 may provide or transmit, to the processor 110, the signal 705 indicating a timing capable of executing the image transmission, in response to terminating (or completing) of the execution of displaying 721 of the first image, as indicated by arrow 757. For example, the signal 705 may indicate a timing 748 of the emission synchronization signal 702. For example, the timing 758 at which the signal 705 is provided may be prior to the timing 748. For example, the signal 705 may be provided to the processor 110 at the timing 758 prior to the timing 748 capable of initiating execution of displaying (e.g., displaying 722 of the second image) of an image subsequent to the first image.

For example, the processor 110 may transmit, to the display driver circuitry 120 through the interface 112, the second image, based on the emission synchronization signal 702 from the timing 748 indicated by the signal 705, as in a state 736. For example, the display driver circuitry 120 may execute displaying 722 of the second image. For example, the display driver circuitry 120 may provide or transmit, to the processor 110, the signal 705 indicating a timing capable of executing the image transmission, in response to terminating (or completing) of the execution of displaying 722 of the second image, as indicated by arrow 759. For example, the signal 705 may indicate a timing 750 of the emission synchronization signal 702. For example, a timing 760 at which the signal 705 is provided may be prior to the timing 750. For example, the signal 705 may be provided to the processor 110 at the timing 760 prior to the timing 750 capable of initiating execution of displaying of an image subsequent to the second image.

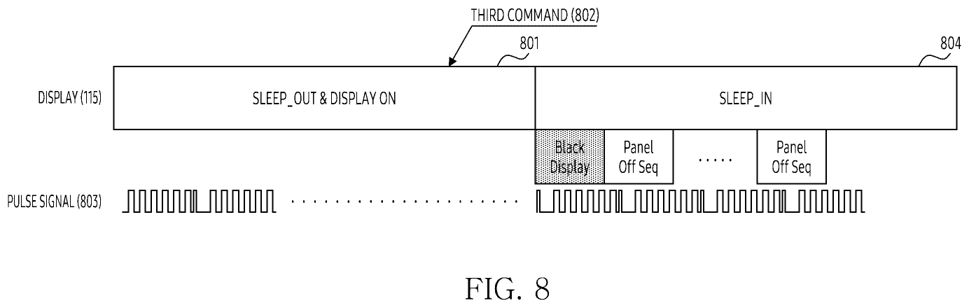

Referring back to FIG. 1, the electronic device 100 may execute operations for terminating driving of the display 115 while executing the image transmission based on the emission synchronization signal for the processor 110. For example, the processor 110 may execute the operations based on providing a third command for the sleep in state of the display 115 to the display driver circuitry 120. The operations may be described in greater detail with reference to FIG. 8.

FIG. 8 is a diagram illustrating an example method for terminating driving of a display according to various embodiments.

Referring to FIG. 8, the processor 110 may execute periodic transmissions of a pulse signal 803 while the display 115 is driven in a sleep-out state and a display-on state, as in a state 801. For example, the pulse signal 803 may correspond to each of the pulse signal 203, the pulse signal 303, the pulse signal 403, the pulse signal 503, the pulse signal 603, and the pulse signal 703 described with reference to FIGS. 2, 3, 4, 5, 6 and 7 (which may be referred to as FIGS. 2 to 7).

For example, the processor 110 may provide, to the display driver circuitry 120 of the display 115 in the state 801, a third command 802 for a sleep in state of the display 115. For example, the state 801 may be changed to a sleep in state, such as a state 804, based on the third command 802. For example, the display 115 may display a black image, as in a state 804, and execute operations to turn off the display panel 140.

For example, at least a portion of the operations may be required to be synchronized with timings identified by the processor 110. For another example, the change to the sleep state may be canceled. However, the disclosure is not limited thereto.

For example, the processor 110 may control the pulse signal 803 for the state 804 changed from the state 801. For example, the processor 110 may start a timer, in response to providing the third command 802. For example, the processor 110 may identify whether the timer started in response to providing the third command 802 is expired. For example, the processor 110 may maintain the periodic transmissions of the pulse signal 803 before the timer is expired. For example, the processor 110 may stop the periodic transmissions of the pulse signal 803, in response to the expiration of the timer or after the expiration of the timer. For example, the pulse signal 803 may be stopped after a reference time (e.g., corresponding to the timer) has elapsed from a timing of providing the third command 802.

As described above, the processor 110 may maintain the pulse signal 803 for a certain period of time after providing the third command 802. For example, the processor 110 may assist operations for turning off the display 115 by maintaining the pulse signal 803. For example, the processor 110 may maintain the periodic transmissions of the pulse signal 803 to assist the operations for turning off the display 115. For example, the number of times the periodic transmissions of the pulse signal 803 executed to assist the operations for turning off the display 115 may be configured (or pre-configured) within the processor 110. As a non-limiting example, the number of times the periodic transmissions of the pulse signal 803 executed from a start timing of the state 804 may be 2 to 8.

FIG. 9 is a block diagram illustrating an example electronic device 901 in a network environment 900 according to various embodiments. Referring to FIG. 9, the electronic device 901 in the network environment 900 may communicate with an electronic device 902 via a first network 998 (e.g., a short-range wireless communication network), or at least one of an electronic device 904 or a server 908 via a second network 999 (e.g., a long-range wireless communication network). According to an embodiment, the electronic device 901 may communicate with the electronic device 904 via the server 908. According to an embodiment, the electronic device 901 may include a processor 920, memory 930, an input module 950, a sound output module 955, a display module 960, an audio module 970, a sensor module 976, an interface 977, a connecting terminal 978, a haptic module 979, a camera module 980, a power management module 988, a battery 989, a communication module 990, a subscriber identification module (SIM) 996, or an antenna module 997. In various embodiments, at least one of the components (e.g., the connecting terminal 978) may be omitted from the electronic device 901, or one or more other components may be added in the electronic device 901. In various embodiments, some of the components (e.g., the sensor module 976, the camera module 980, or the antenna module 997) may be implemented as a single component (e.g., the display module 960).

The processor 920 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions. The processor 920 may execute, for example, software (e.g., a program 940) to control at least one other component (e.g., a hardware or software component) of the electronic device 901 coupled with the processor 920, and may perform various data processing or computation. According to an embodiment, as at least part of the data processing or computation, the processor 920 may store a command or data received from another component (e.g., the sensor module 976 or the communication module 990) in volatile memory 932, process the command or the data stored in the volatile memory 932, and store resulting data in non-volatile memory 934. According to an embodiment, the processor 920 may include a main processor 921 (e.g., a central processing unit (CPU) or an application processor (AP)), or an auxiliary processor 923 (e.g., a graphics processing unit (GPU), a neural processing unit (NPU), an image signal processor (ISP), a sensor hub processor, or a communication processor (CP)) that is operable independently from, or in conjunction with, the main processor 921. For example, when the electronic device 901 includes the main processor 921 and the auxiliary processor 923, the auxiliary processor 923 may be adapted to consume less power than the main processor 921, or to be specific to a specified function. The auxiliary processor 923 may be implemented as separate from, or as part of the main processor 921.

The auxiliary processor 923 may control at least some of functions or states related to at least one component (e.g., the display module 960, the sensor module 976, or the communication module 990) among the components of the electronic device 901, instead of the main processor 921 while the main processor 921 is in an inactive (e.g., sleep) state, or together with the main processor 921 while the main processor 921 is in an active state (e.g., executing an application). According to an embodiment, the auxiliary processor 923 (e.g., an image signal processor or a communication processor) may be implemented as part of another component (e.g., the camera module 980 or the communication module 990) functionally related to the auxiliary processor 923. According to an embodiment, the auxiliary processor 923 (e.g., the neural processing unit) may include a hardware structure specified for artificial intelligence model processing. An artificial intelligence model may be generated by machine learning. Such learning may be performed, e.g., by the electronic device 901 where the artificial intelligence is performed or via a separate server (e.g., the server 908). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 930 may store various data used by at least one component (e.g., the processor 920 or the sensor module 976) of the electronic device 901. The various data may include, for example, software (e.g., the program 940) and input data or output data for a command related thereto. The memory 930 may include the volatile memory 932 or the non-volatile memory 934.

The program 940 may be stored in the memory 930 as software, and may include, for example, an operating system (OS) 942, middleware 944, or an application 946.

The input module 950 may receive a command or data to be used by another component (e.g., the processor 920) of the electronic device 901, from the outside (e.g., a user) of the electronic device 901. The input module 950 may include, for example, a microphone, a mouse, a keyboard, a key (e.g., a button), or a digital pen (e.g., a stylus pen).

The sound output module 955 may output sound signals to the outside of the electronic device 901. The sound output module 955 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 960 may visually provide information to the outside (e.g., a user) of the electronic device 901. The display module 960 may include, for example, a display, a hologram device, or a projector and control circuitry to control a corresponding one of the display, hologram device, and projector. According to an embodiment, the display module 960 may include a touch sensor adapted to detect a touch, or a pressure sensor adapted to measure the intensity of force incurred by the touch.

The audio module 970 may convert a sound into an electrical signal and vice versa. According to an embodiment, the audio module 970 may obtain the sound via the input module 950, or output the sound via the sound output module 955 or a headphone of an external electronic device (e.g., an electronic device 902) directly (e.g., wiredly) or wirelessly coupled with the electronic device 901.

The sensor module 976 may detect an operational state (e.g., power or temperature) of the electronic device 901 or an environmental state (e.g., a state of a user) external to the electronic device 901, and then generate an electrical signal or data value corresponding to the detected state. According to an embodiment, the sensor module 976 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 977 may support one or more specified protocols to be used for the electronic device 901 to be coupled with the external electronic device (e.g., the electronic device 902) directly (e.g., wiredly) or wirelessly. According to an embodiment, the interface 977 may include, for example, a high definition multimedia interface (HDMI), a universal serial bus (USB) interface, a secure digital (SD) card interface, or an audio interface.

A connecting terminal 978 may include a connector via which the electronic device 901 may be physically connected with the external electronic device (e.g., the electronic device 902). According to an embodiment, the connecting terminal 978 may include, for example, an HDMI connector, a USB connector, a SD card connector, or an audio connector (e.g., a headphone connector).

The haptic module 979 may convert an electrical signal into a mechanical stimulus (e.g., a vibration or a movement) or electrical stimulus which may be recognized by a user via his tactile sensation or kinesthetic sensation. According to an embodiment, the haptic module 979 may include, for example, a motor, a piezoelectric element, or an electric stimulator.

The camera module 980 may capture a still image or moving images. According to an embodiment, the camera module 980 may include one or more lenses, image sensors, image signal processors, or flashes.

The power management module 988 may manage power supplied to the electronic device 901. According to an embodiment, the power management module 988 may be implemented as at least part of, for example, a power management integrated circuit (PMIC).

The battery 989 may supply power to at least one component of the electronic device 901. According to an embodiment, the battery 989 may include, for example, a primary cell which is not rechargeable, a secondary cell which is rechargeable, or a fuel cell.

The communication module 990 may support establishing a direct (e.g., wired) communication channel or a wireless communication channel between the electronic device 901 and the external electronic device (e.g., the electronic device 902, the electronic device 904, or the server 908) and performing communication via the established communication channel. The communication module 990 may include one or more communication processors that are operable independently from the processor 920 (e.g., the application processor (AP)) and supports a direct (e.g., wired) communication or a wireless communication. According to an embodiment, the communication module 990 may include a wireless communication module 992 (e.g., a cellular communication module, a short-range wireless communication module, or a global navigation satellite system (GNSS) communication module) or a wired communication module 994 (e.g., a local area network (LAN) communication module or a power line communication (PLC) module).

A corresponding one of these communication modules may communicate with the external electronic device via the first network 998 (e.g., a short-range communication network, such as Bluetooth™, wireless-fidelity (Wi-Fi) direct, or infrared data association (IrDA)) or the second network 999 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 992 may identify and authenticate the electronic device 901 in a communication network, such as the first network 998 or the second network 999, using subscriber information (e.g., international mobile subscriber identity (IMSI)) stored in the subscriber identification module 996.

The wireless communication module 992 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 992 may support a high-frequency band (e.g., the mm Wave band) to achieve, e.g., a high data transmission rate. The wireless communication module 992 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 992 may support various requirements specified in the electronic device 901, an external electronic device (e.g., the electronic device 904), or a network system (e.g., the second network 999). According to an embodiment, the wireless communication module 992 may support a peak data rate (e.g., 20 Gbps or more) for implementing eMBB, loss coverage (e.g., 964 dB or less) for implementing mMTC, or U-plane latency (e.g., 0.5 ms or less for each of downlink (DL) and uplink (UL), or a round trip of 9 ms or less) for implementing URLLC.

The antenna module 997 may transmit or receive a signal or power to or from the outside (e.g., the external electronic device) of the electronic device 901. According to an embodiment, the antenna module 997 may include an antenna including a radiating element including a conductive material or a conductive pattern formed in or on a substrate (e.g., a printed circuit board (PCB)). According to an embodiment, the antenna module 997 may include a plurality of antennas (e.g., array antennas). In such a case, at least one antenna appropriate for a communication scheme used in the communication network, such as the first network 998 or the second network 999, may be selected, for example, by the communication module 990 (e.g., the wireless communication module 992) from the plurality of antennas. The signal or the power may then be transmitted or received between the communication module 990 and the external electronic device via the selected at least one antenna. According to an embodiment, another component (e.g., a radio frequency integrated circuit (RFIC)) other than the radiating element may be additionally formed as part of the antenna module 997.

According to various embodiments, the antenna module 997 may form a mmWave antenna module. According to an embodiment, the mmWave antenna module may include a printed circuit board, an RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 901 and the external electronic device 904 via the server 908 coupled with the second network 999. Each of the electronic devices 902 or 904 may be a device of a same type as, or a different type, from the electronic device 901. According to an embodiment, all or some of operations to be executed at the electronic device 901 may be executed at one or more of the external electronic devices 902, 904, or 908. For example, if the electronic device 901 should perform a function or a service automatically, or in response to a request from a user or another device, the electronic device 901, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 901. The electronic device 901 may provide the outcome, with or without further processing of the outcome, as at least part of a reply to the request. To that end, a cloud computing, distributed computing, mobile edge computing (MEC), or client-server computing technology may be used, for example. The electronic device 901 may provide ultra low-latency services using, e.g., distributed computing or mobile edge computing. In an embodiment, the external electronic device 904 may include an internet-of-things (IoT) device. The server 908 may be an intelligent server using machine learning and/or a neural network. According to an embodiment, the external electronic device 904 or the server 908 may be included in the second network 999. The electronic device 901 may be applied to intelligent services (e.g., smart home, smart city, smart car, or healthcare) based on 5G communication technology or IoT-related technology.

FIG. 10 is a block diagram 1000 illustrating an example configuration of the display module 960 according to various embodiments. Referring to FIG. 10, the display module 960 may include a display 1010 and a display driver integrated circuit (DDI) 1030 to control the display 1010. The DDI 1030 may include an interface module (e.g., including interface circuitry) 1031, memory 1033 (e.g., buffer memory), an image processing module (e.g., including image processing circuitry) 1035, and/or a mapping module (e.g., including mapping circuitry) 1037. The DDI 1030 may receive image information that contains image data or an image control signal corresponding to a command to control the image data from another component of the electronic device 901 via the interface module 1031. For example, according to an embodiment, the image information may be received from the processor 920 (e.g., the main processor 921 (e.g., an application processor)) or the auxiliary processor 923 (e.g., a graphics processing unit) operated independently from the function of the main processor 921. The DDI 1030 may communicate, for example, with touch circuitry 1050 or the sensor module 976 via the interface module 1031. The DDI 1030 may also store at least part of the received image information in the memory 1033, for example, on a frame by frame basis. The image processing module 1035 may perform pre-processing or post-processing (e.g., adjustment of resolution, brightness, or size) with respect to at least part of the image data. According to an embodiment, the pre-processing or post-processing may be performed, for example, based at least in part on one or more characteristics of the image data or one or more characteristics of the display 1010. The mapping module 1037 may generate a voltage value or a current value corresponding to the image data pre-processed or post-processed by the image processing module 1035. According to an embodiment, the generating of the voltage value or current value may be performed, for example, based at least in part on one or more attributes of the pixels (e.g., an array, such as an RGB stripe or a pentile structure, of the pixels, or the size of each subpixel). At least some pixels of the display 1010 may be driven, for example, based at least in part on the voltage value or the current value such that visual information (e.g., a text, an image, or an icon) corresponding to the image data may be displayed via the display 1010.

According to an embodiment, the display module 960 may further include touch circuitry 1050. The touch circuitry 1050 may include a touch sensor 1051 and a touch sensor IC 1053 to control the touch sensor 1051. The touch sensor IC 1053 may control the touch sensor 1051 to sense a touch input or a hovering input with respect to a certain position on the display 1010. To achieve this, for example, the touch sensor 1051 may detect (e.g., measure) a change in a signal (e.g., a voltage, a quantity of light, a resistance, or a quantity of one or more electric charges) corresponding to the certain position on the display 1010. The touch circuitry 1050 may provide input information (e.g., a position, an area, a pressure, or a time) indicative of the touch input or the hovering input detected via the touch sensor 1051 to the processor 920. According to an embodiment, at least part (e.g., the touch sensor IC 1053) of the touch circuitry 1050 may be formed as part of the display 1010 or the DDI 1030, or as part of another component (e.g., the auxiliary processor 923) disposed outside the display module 960.

According to an embodiment, the display module 960 may further include at least one sensor (e.g., a fingerprint sensor, an iris sensor, a pressure sensor, or an illuminance sensor) of the sensor module 976 or a control circuit for the at least one sensor. In such a case, the at least one sensor or the control circuit for the at least one sensor may be embedded in one portion of a component (e.g., the display 1010, the DDI 1030, or the touch circuitry 1050)) of the display module 960. For example, when the sensor module 976 embedded in the display module 960 includes a biometric sensor (e.g., a fingerprint sensor), the biometric sensor may obtain biometric information (e.g., a fingerprint image) corresponding to a touch input received via a portion of the display 1010. As another example, when the sensor module 976 embedded in the display module 960 includes a pressure sensor, the pressure sensor may obtain pressure information corresponding to a touch input received via a partial or whole area of the display 1010. According to an embodiment, the touch sensor 1051 or the sensor module 976 may be disposed between pixels in a pixel layer of the display 1010, or over or under the pixel layer.

As described above, an electronic device 100 may comprise a processor 110, and a display 115 including display driver circuitry 120 and a display panel 140. According to an embodiment, the processor 110 may be configured to, before providing, to the display driver circuitry 120, a first command for a sleep out state of the display 115, enable periodic transmissions of a pulse signal from the processor 110 to the display driver circuitry 120 to synchronize at least one timing for the display driver circuitry 120 with at least one timing for the processor 110. According to an embodiment, the processor 110 may be configured to, based on informing, to the display driver circuitry 120, using the periodic transmissions, a timing of an emission synchronization signal for the processor 110 usable for an image transmission from the processor 110 to the display driver circuitry 120, provide, to the display driver circuitry 120, a second command for a display on state of the display 115.

According to an embodiment, the display driver circuitry 120 may be configured to, based on a vertical synchronization signal for the display driver circuitry 120 obtained in accordance with the timing informed to the display driver circuitry 120 based on the periodic transmissions, execute displaying of a black image on the display panel 140. According to an embodiment, the display driver circuitry 120 may be configured to, while the black image is maintained on the display panel 140 after terminating of the execution, extend the synchronization signal for the display driver circuitry 120. According to an embodiment, the display driver circuitry 120 may be configured to, while the black image is maintained on the display panel 140, receive an image transmitted from the processor 110 based on the emission synchronization signal for the processor 110 after providing the second command to the display driver circuitry 120.

According to an embodiment, the display driver circuitry 120 may be configured to, in response to the image, obtain the vertical synchronization signal for the display driver circuitry 120. According to an embodiment, the display driver circuitry 120 may be configured to, based on the vertical synchronization signal for the display driver circuitry 120 obtained in response to the image, display, on the display panel 140, the image.

According to an embodiment, a first refresh rate for the displaying of the black image may be different from a second refresh rate for the displaying of the image.

According to an embodiment, a first refresh rate for the displaying of the black image may be pre-defined in each of the processor 110 and the display driver circuitry 120 before the black image is displayed. According to an embodiment, a second refresh rate for the displaying of the image may be identified by the processor 110 from among the processor 110 and the display driver circuitry 120.

According to an embodiment, the display driver circuitry 120 may be configured to, based on a vertical synchronization signal for the display driver circuitry 120 obtained in accordance with the timing informed to the display driver circuitry 120 based on the periodic transmissions, execute a first displaying of a black image on the display panel 140. According to an embodiment, the display driver circuitry 120 may be configured to, based on the vertical synchronization signal for the display driver circuitry 120 maintained after the first displaying of the black image, execute at least one second displaying of the black image on the display panel 140. According to an embodiment, the display driver circuitry 120 may be configured to, before a third displaying of the black image is executed after terminating of the execution of the at least one second displaying of the black image, receive an image transmitted from the processor 110 based on the emission synchronization signal for the processor 110 after providing the second command to the display driver circuitry 120. According to an embodiment, the display driver circuitry 120 may be configured to, based on the vertical synchronization signal for the display driver circuitry 120 maintained after the at least one second displaying of the black image, display, on the display panel 140, the image.

According to an embodiment, a first refresh rate for the first displaying of the black image may be equal to a second refresh rate for the at least one second displaying of the black image. According to an embodiment, the second refresh rate may be equal to a third refresh rate for the displaying of the image.

According to an embodiment, each of the first refresh rate, the second refresh rate, and the third refresh rate may be pre-defined in each of the processor 110 and the display driver circuitry 120 before the black image is displayed.

According to an embodiment, the display driver circuitry 120 may be configured to, based on a vertical synchronization signal for the display driver circuitry 120 obtained in accordance with the timing informed to the display driver circuitry 120 based on the periodic transmissions, execute displaying of a black image on the display panel 140. According to an embodiment, the display driver circuitry 120 may be configured to, in response to terminating of the execution, change a state of a signal provided from the display driver circuitry 120 to the processor 110 from a second state indicating to disable the image transmission to a first state indicating to enable the image transmission. According to an embodiment, the display driver circuitry 120 may be configured to, while the black image is maintained on the display panel 140 after terminating of the execution, extend the vertical synchronization signal for the display driver circuitry 120, and maintain the state of the signal as the first state. According to an embodiment, the display driver circuitry 120 may be configured to, while the black image is maintained on the display panel 140, receive an image transmitted from the processor 110 based on the signal in the first state changed from the second state, and the emission synchronization signal for the processor 110 after providing the second command to the display driver circuitry 120. According to an embodiment, the display driver circuitry 120 may be configured to, in response to the image, obtain the vertical synchronization signal for the display driver circuitry 120. According to an embodiment, the display driver circuitry 120 may be configured to, based on the vertical synchronization signal for the display driver circuitry 120 obtained in response to the image, display, on the display panel 140, the image.

According to an embodiment, the display driver circuitry 120 may be configured to, in response to the image transmitted from the processor 110, change the state of the signal from the first state to the second state.

According to an embodiment, the display driver circuitry 120 may be configured to, based on a vertical synchronization signal for the display driver circuitry 120 obtained in accordance with the timing informed to the display driver circuitry 120 based on the periodic transmissions, display at least one displaying of a black image on the display panel 140. According to an embodiment, the display driver circuitry 120 may be configured to, before initiating, based on the vertical synchronization signal for the display driver circuitry 120 maintained during the at least one displaying, an execution of displaying of the black image subsequent to the at least one displaying, provide a signal indicating a timing of the image transmission to the processor 110. According to an embodiment, the display driver circuitry 120 may be configured to receive an image transmitted from the processor 110 based on the emission synchronization signal for the processor 110, and the signal after providing the second command to the display driver circuitry 120. According to an embodiment, the display driver circuitry 120 may be configured to, based on the vertical synchronization signal for the display driver circuitry 120 maintained after the execution of the at least one displaying, display, on the display panel 140, the image.

According to an embodiment, a first refresh rate for the at least one displaying of the black image may be equal to a second refresh rate for the displaying of the image.

According to an embodiment, the display driver circuitry 120 may be configured to, based on a vertical synchronization signal for the display driver circuitry 120 obtained in accordance with the timing informed to the display driver circuitry 120 based on the periodic transmissions, execute a displaying of a black image on the display panel 140. According to an embodiment, the display driver circuitry 120 may be configured to, while the displaying of the black image is executed or the black image is maintained on the display panel 140, receive a black image transmitted from the processor 110 based on the emission synchronization signal for the processor 110 after providing the second command to the display driver circuitry 120. According to an embodiment, the display driver circuitry 120 may be configured to, in response to terminating of the reception of the black image, change a state of a signal provided from the display driver circuitry 120 to the processor 110 from a second state indicating to disable the image transmission to a first state indicating to enable the image transmission. According to an embodiment, the display driver circuitry 120 may be configured to receive an image, subsequent to the black image, transmitted from the processor 110 based on the signal in the first state changed from the second state and the emission synchronization signal for the processor 110. According to an embodiment, the display driver circuitry 120 may be configured to, based on the vertical synchronization signal for the display drive circuitry 120 obtained in response to the image, display, on the display panel 140, the image.

According to an embodiment, the display driver circuitry 120 may be configured to, in response to the image transmitted from the processor 110, change the state of the signal from the first state to the second state.

According to an embodiment, the display driver circuitry 120 may be configured to, before the execution of the displaying of the black image, change the state of the signal from the first state to the second state. According to an embodiment, the processor 110 may be configured to, while the displaying of the black image is executed, transmit, to the display driver circuitry 120, the black image independently of the signal in the second state changed from the first state before the execution of the displaying of the black image.

According to an embodiment, the processor 110 may be configured to, in response to transmitting the black image to the display driver circuitry 120, initiate identifying the state of the signal.

According to an embodiment, the vertical synchronization signal for the display driver circuitry 120 may be extended between the displaying of the black image and the displaying of the image.

According to an embodiment, the vertical synchronization signal for the display driver circuitry 120 may be obtained in response to the black image received from the processor 110.

According to an embodiment, the display driver circuitry 120 may be configured to execute at least one displaying of the black image on the display panel 140, based on a vertical synchronization signal for the display driver circuitry 120 obtained according to the timing informed to the display driver circuitry 120 based on the periodic transmissions. According to an embodiment, the display driver circuitry 120 may be configured to receive a black image transmitted from the processor 110 based on the emission synchronization signal for the processor 110 after providing the second command to the display driver circuitry 120, while the at least one displaying is executed. According to an embodiment, the display driver circuitry 120 may be configured to provide, to the processor 110, a signal indicating a timing of the image transmission, in response to terminating of the reception of the black image. According to an embodiment, the display driver circuitry 120 may be configured to receive an image subsequent to the black image, transmitted from the processor 110 based on the signal and the emission synchronization signal for the processor 110. According to an embodiment, the display driver circuitry 120 may be configured to display the image on the display panel 140.

According to an embodiment, the display driver circuitry 120 may be configured to provide the signal to the processor 110, in response to terminating of the reception of the image. According to an embodiment, the processor 110 may be configured to initiate identifying the signal, in response to the transmission of the black image.

According to an embodiment, the display driver circuitry 120 may be configured to obtain the vertical synchronization signal for the display driver circuitry 120, in response to the black image transmitted from the processor 110. According to an embodiment, the signal may be provided to the display driver circuitry 120 based on the vertical synchronization signal for the display driver circuitry 120 obtained in response to the black image transmitted from the processor 110.

According to an embodiment, the processor 110 may be configured to provide a third command for a sleep in state of the display 115 to the display driver circuitry 120, based on the emission synchronization signal for the processor 110. According to an embodiment, the processor 110 may be configured to identify whether a timer started in response to providing the third command has expired. According to an embodiment, the processor 110 may be configured to maintain the periodic transmissions before the expiration of the timer. According to an embodiment, the processor 110 may be configured to cease the periodic transmissions after the expiration of the timer.

The electronic device according to various embodiments may be one of various types of electronic devices. The electronic devices may include, for example, a portable communication device (e.g., a smartphone), a computer device, a portable multimedia device, a portable medical device, a camera, a wearable device, a home appliance, or the like. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” or “connected with” another element (e.g., a second element), the element may be coupled with the other element directly (e.g., wiredly), wirelessly, or via a third element.

As used in connection with various embodiments of the disclosure, the term “module” may include a unit implemented in hardware, software, or firmware, or any combination thereof, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 940) including one or more instructions that are stored in a storage medium (e.g., internal memory 936 or external memory 938) that is readable by a machine (e.g., the electronic device 901). For example, a processor (e.g., the processor 920) of the machine (e.g., the electronic device 901) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Wherein, the “non-transitory” storage medium is a tangible device, and may not include a signal (e.g., an electromagnetic wave), but this term does not differentiate between a case in which data is semi-permanently stored in the storage medium and a case in which the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

While the disclosure has been illustrated and described with reference to various example embodiments, it will be understood that the various example embodiments are intended to be illustrative, not limiting. It will be further understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

What is claimed is:

1. An electronic device comprising:
at least one processor comprising processing circuitry;
memory comprising one or more storage media storing instructions; and
a display including display driver circuitry and a display panel,
wherein the instructions, when executed by the at least one processor individually or collectively, cause the electronic device to:
before providing, to the display driver circuitry, a first command for a sleep out state of the display, enable periodic transmissions of a pulse signal from the at least one processor to the display driver circuitry to synchronize at least one timing for the display driver circuitry with at least one timing for the at least one processor; and
based on informing, to the display driver circuitry, using the periodic transmissions, a timing of an emission synchronization signal for the at least one processor usable for an image transmission from the at least one processor to the display driver circuitry, provide, to the display driver circuitry, a second command for a display on state of the display.

2. The electronic device of claim 1, wherein the display driver circuitry is configured to:
based on a vertical synchronization signal for the display driver circuitry obtained according to the timing informed to the display driver circuitry based on the periodic transmissions, execute displaying of a black image on the display panel;
while the black image is maintained on the display panel after terminating of the execution, extend the synchronization signal for the display driver circuitry;
while the black image is maintained on the display panel, receive an image transmitted from the at least one processor based on the emission synchronization signal for the at least one processor after providing the second command to the display driver circuitry;
in response to the image, obtain the vertical synchronization signal for the display driver circuitry; and
based on the vertical synchronization signal for the display driver circuitry obtained in response to the image, display, on the display panel, the image.

3. The electronic device of claim 2, wherein a first refresh rate for the displaying of the black image is different from a second refresh rate for the displaying of the image.

4. The electronic device of claim 2, wherein a first refresh rate for the displaying of the black image is defined in each of the at least one processor and the display driver circuitry before the black image is displayed, and
wherein a second refresh rate for the displaying of the image is identified by the at least one processor from among the at least one processor and the display driver circuitry.

5. The electronic device of claim 1, wherein the display driver circuitry is configured to:
based on a vertical synchronization signal for the display driver circuitry obtained according to the timing informed to the display driver circuitry based on the periodic transmissions, execute a first displaying of a black image on the display panel;
based on the vertical synchronization signal for the display driver circuitry maintained after the first displaying of the black image, execute at least one second displaying of the black image on the display panel;
before a third displaying of the black image is executed after terminating of the execution of the at least one second displaying of the black image, receive an image transmitted from the at least one processor based on the emission synchronization signal for the at least one processor after providing the second command to the display driver circuitry; and
based on the vertical synchronization signal for the display driver circuitry maintained after the at least one second displaying of the black image, display, on the display panel, the image.

6. The electronic device of claim 5, wherein a first refresh rate for the first displaying of the black image is equal to a second refresh rate for the at least one second displaying of the black image, and
wherein the second refresh rate is equal to a third refresh rate for the displaying of the image.

7. The electronic device of claim 5, wherein each of the first refresh rate, the second refresh rate, and the third refresh rate is defined in each of the at least one processor and the display driver circuitry before the black image is displayed.

8. The electronic device of claim 1, wherein the display driver circuitry is configured to:
based on a vertical synchronization signal for the display driver circuitry obtained according to the timing informed to the display driver circuitry based on the periodic transmissions, execute displaying of a black image on the display panel;
in response to terminating of the execution, change a state of a signal provided from the display driver circuitry to the at least one processor from a second state indicating to disable the image transmission to a first state indicating to enable the image transmission;
while the black image is maintained on the display panel after terminating of the execution:
extend the vertical synchronization signal for the display driver circuitry, and
maintain the state of the signal as the first state;
while the black image is maintained on the display panel, receive an image transmitted from the at least one processor based on the signal in the first state changed from the second state, and the emission synchronization signal for the at least one processor after providing the second command to the display driver circuitry;
in response to the image, obtain the vertical synchronization signal for the display driver circuitry; and
based on the vertical synchronization signal for the display driver circuitry obtained in response to the image, display, on the display panel, the image.

9. The electronic device of claim 8, wherein the display driver circuitry is further configured to:
in response to the image transmitted from the at least one processor, change the state of the signal from the first state to the second state.

10. The electronic device of claim 1, wherein the display driver circuitry is configured to:
based on a vertical synchronization signal for the display driver circuitry obtained according to the timing informed to the display driver circuitry based on the periodic transmissions, display at least one displaying of a black image on the display panel;
before initiating, based on the vertical synchronization signal for the display driver circuitry maintained during the at least one displaying of the black image, an execution of displaying of the black image subsequent to the at least one displaying of the black image, provide a signal indicating a timing of the image transmission to the at least one processor;
receive an image transmitted from the at least one processor based on the emission synchronization signal for the at least one processor, and the signal after providing the second command to the display driver circuitry; and
based on the vertical synchronization signal for the display driver circuitry maintained after the execution of the at least one displaying of the black image, display, on the display panel, the image.

11. The electronic device of claim 10, wherein a first refresh rate for the at least one displaying of the black image is equal to a second refresh rate for the displaying of the image.

12. The electronic device of claim 1, wherein the display driver circuitry is configured to:
based on a vertical synchronization signal for the display driver circuitry obtained according to the timing informed to the display driver circuitry based on the periodic transmissions, execute a displaying of a black image on the display panel;
while the displaying of the black image is executed or the black image is maintained on the display panel, receive a black image transmitted from the at least one processor based on the emission synchronization signal for the at least one processor after providing the second command to the display driver circuitry;
in response to terminating of the reception of the black image, change a state of a signal provided from the display driver circuitry to the at least one processor from a second state indicating to disable the image transmission to a first state indicating to enable the image transmission;
receive an image, subsequent to the black image, transmitted from the at least one processor based on the signal in the first state changed from the second state and the emission synchronization signal for the at least one processor; and
based on the vertical synchronization signal for the display drive circuitry obtained in response to the image, display, on the display panel, the image.

13. The electronic device of claim 12, wherein the display driver circuitry is further configured to:
in response to the image transmitted from the at least one processor, change the state of the signal from the first state to the second state.

14. The electronic device of claim 12, wherein the display driver circuitry is further configured to:
before the execution of the displaying of the black image, change the state of the signal from the first state to the second state, and
wherein the instructions, when executed by the at least one processor individually or collectively, cause the electronic device to:
while the displaying of the black image is executed, transmit, to the display driver circuitry, the black image independently of the signal in the second state changed from the first state before the execution of the displaying of the black image.

15. The electronic device of claim 14, wherein the instructions, when executed by the at least one processor individually or collectively, cause the electronic device to:
in response to transmitting the black image to the display driver circuitry, initiate identifying the state of the signal.

16. The electronic device of claim 12, wherein the vertical synchronization signal for the display driver circuitry is extended between the displaying of the black image and the displaying of the image.

17. The electronic device of claim 16, wherein the vertical synchronization signal for the display driver circuitry is obtained in response to the black image received from the at least one processor.

18. The electronic device of claim 1, wherein the display driver circuitry is configured to:
based on a vertical synchronization signal for the display driver circuitry obtained according to the timing informed to the display driver circuitry based on the periodic transmissions, execute at least one displaying of the black image on the display panel;
while the at least one displaying is executed, receive a black image transmitted from the at least one processor based on the emission synchronization signal for the at least one processor after providing the second command to the display driver circuitry;
provide, to the at least one processor, a signal indicating a timing of the image transmission, in response to terminating of the reception of the black image;
receive an image subsequent to the black image, transmitted from the at least one processor based on the signal and the emission synchronization signal for the at least one processor; and
display the image on the display panel.

19. The electronic device of claim 18, wherein the display driver circuitry is configured to, in response to terminating of the reception of the image, provide the signal to the at least one processor, and
wherein the instructions, when executed by the at least one processor individually or collectively, cause the electronic device to, in response to the transmission of the black image, initiate identifying the signal.

20. The electronic device of claim 18, wherein the display driver circuitry is configured to, in response to the black image transmitted from the at least one processor, obtain the vertical synchronization signal for the display driver circuitry, and
wherein the signal is provided to the display driver circuitry based on the vertical synchronization signal for the display driver circuitry obtained in response to the black image transmitted from the at least one processor.
